(19) United States
(12) Patent Application Publication
(10) Pub. No.: US 2014/0123249 A1
(43) Pub. Date: May 1, 2014

(54) Behavioral Fingerprinting Via Corroborative User Device

(71) Applicant: ELWHA LLC, A LIMITED LIABILITY CORPORATION OF THE, Bellevue, WA (US)

(72) Inventors: Marc E. Davis, San Francisco, CA (US); Matthew G. Dyor, Bellevue, WA (US); Daniel A. Gerrity, Seattle, WA (US); Xeudong Huang, Bellevue, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Nathan P. Myhrvoid, Bellevue, WA (US); Clarence T. Tegreene, Mercer Island, WA (US)

(73) Assignee: Elwha LLC, a limited liability corporation of the State of Delaware, Bellevue, WA (US)

(21) Appl. No.: 13/665,841

(22) Filed: Oct. 31, 2012

(51) Int. Cl. G06F 21/44

(52) U.S. Cl. CPC G06F 21/44
USPC 726/5

(57) ABSTRACT

Disclosed herein are example embodiments for behavioral fingerprinting via corroborative user device. For certain example embodiments, one or more devices may (i) ascertain at least one indicator of a proximity of at least one corroborative user device that is affiliated with a behavioral fingerprint and (ii) incorporate the at least one indicator of a proximity of the at least one corroborative user device into an authentication-related analysis for a user device that is associated with the behavioral fingerprint. However, claimed subject matter is not limited to any particular described embodiments, implementations, examples, or so forth.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

(1) For purposes of the USPTO extra-statutory requirements, the present application claims benefit of priority of U.S. Provisional Patent Application No. 61/632,836 (Atty. Docket No. SE1-0540-US), entitled “Behavioral Fingerprint Based Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 24 Sep. 2011, which was filed within the twelve months preceding the filing date of the present application or is an application of which a currently co-pending application is entitled to the benefit of the filing date.

(2) For purposes of the USPTO extra-statutory requirements, the present application claims benefit of priority of U.S. Provisional Patent Application No. 61/572,309 (Atty. Docket No. SE1-0541-US), entitled “Network Acquired Behavioral Fingerprint for Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 13 Oct. 2011, which was filed within the twelve months preceding the filing date of the present application or is an application of which a currently co-pending application is entitled to the benefit of the filing date.

(3) For purposes of the USPTO extra-statutory requirements, the present application constitutes a continuation-in-part of U.S. patent application Ser. No. 13/373,685 (Atty. Docket No. SE1-0542-US), entitled “Behavioral Fingerprint Device Identification”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011, which is currently co-pending or is an application of which a currently co-pending application is entitled to the benefit of the filing date.

(4) For purposes of the USPTO extra-statutory requirements, the present application constitutes a continuation-in-part of U.S. patent application Ser. No. 13/373,684 (Atty. Docket No. SE1-0543-US), entitled “Behavioral Fingerprint Controlled Automatic Task Determination”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011, which is currently co-pending or is an application of which a currently co-pending application is entitled to the benefit of the filing date.

(5) For purposes of the USPTO extra-statutory requirements, the present application constitutes a continuation-in-part of U.S. patent application Ser. No. 13/373,680 (Atty. Docket No. SE1-0544-US), entitled “Behavioral Fingerprint Controlled Theft Detection and Recovery”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011, which is currently co-pending or is an application of which a currently co-pending application is entitled to the benefit of the filing date.

(6) For purposes of the USPTO extra-statutory requirements, the present application constitutes a continuation-in-part of U.S. patent application Ser. No. 13/373,677 (Atty. Docket No. SE1-0545-US), entitled “Trust Verification Schema Based Transaction Authorization”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011, which is currently co-pending or is an application of which a currently co-pending application is entitled to the benefit of the filing date.

(7) For purposes of the USPTO extra-statutory requirements, the present application constitutes a continuation-in-part of U.S. patent application Ser. No. 13/373,682 (Atty. Docket No. SE1-0546-US), entitled “Social Network Based Trust Verification Schema”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 23 Nov. 2011, which is currently co-pending or is an application of which a currently co-pending application is entitled to the benefit of the filing date.

(8) For purposes of the USPTO extra-statutory requirements, the present application constitutes a continuation-in-part of U.S. patent application Ser. No. 13/475,564 (Atty. Docket No. SE1-0547-US), entitled “Behavioral Fingerprint Based Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 18 May 2012, which is currently co-pending or is an application of which a currently co-pending application is entitled to the benefit of the filing date.

(9) For purposes of the USPTO extra-statutory requirements, the present application constitutes a continuation-in-part of U.S. patent application Ser. No. 13/538,385 (Atty. Docket No. SE1-0548-US), entitled “Network Acquired Behavioral Fingerprint for Authentication”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 29 Jun. 2012, which is currently co-pending or is an application of which a currently co-pending application is entitled to the benefit of the filing date.

(10) For purposes of the USPTO extra-statutory requirements, the present application constitutes a continuation-in-part of U.S. patent application Ser. No. 13/552,502 (Atty. Docket No. SE1-0549-US), entitled “Relationship Based Trust Verification Schema”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 18 Jul. 2012, which is currently co-pending or is an application of which a currently co-pending application is entitled to the benefit of the filing date.

(11) For purposes of the USPTO extra-statutory requirements, the present application constitutes a continuation-in-part of U.S. patent application Ser. No. 13/563,599 (Atty. Docket No. SE1-0636-US), entitled “Multi-Device Behavioral Fingerprinting”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Jul. 2012, which is currently co-pending or is an application of which a currently co-pending application is entitled to the benefit of the filing date.

(12) For purposes of the USPTO extra-statutory requirements, the present application constitutes a continuation-in-part of U.S. patent application Ser. No. 13/602,061 (Atty. Docket No. SE1-0637-US), entitled “Behavioral Fingerprinting Via Social Networking Interaction”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Aug. 2012, which is currently co-pending or is an application of which a currently co-pending application is entitled to the benefit of the filing date.

(13) For purposes of the USPTO extra-statutory requirements, the present application constitutes a continuation-in-part of U.S. patent application Ser. No. 13/631,667 (Atty. Docket No. SE1-0638-US), entitled “Behavioral Fingerprinting Via Derived Personal Relation”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 28 Sep. 2012, which is currently co-pending or is an application of which a currently co-pending application is entitled to the benefit of the filing date.

(14) For purposes of the USPTO extra-statutory requirements, the present application constitutes a continuation-in-part of U.S. patent application Ser. No. 13/664,830 (Atty. Docket No. SE1-0639-US), entitled “Behavioral Fingerprinting Via Inferred Personal Relation”, naming Marc E. Davis, Matthew G. Dyor, Daniel A. Gerrity, Xuedong (XD) Huang, Roderick A. Hyde, Royce A. Levien, Richard T. Lord, Robert W. Lord, Mark A. Malamud, Nathan Myhrvold, and Clarence T. Tegreene as inventors, filed 31 Oct. 2012, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### BRIEF DESCRIPTION OF THE FIGURES

FIG. 1 is a schematic diagram of a user device, a server device, and at least one behavioral fingerprint, any of which may be involved individually or jointly in example authentication scenarios in accordance with certain example embodiments.

FIG. 2A is a schematic diagram of multiple user devices, multiple server devices, and at least one behavioral fingerprint, any of which may be involved individually or jointly in example authentication scenarios in accordance with certain example embodiments.

FIG. 2B is a schematic diagram of multiple user devices, multiple server devices, and multiple example locations for at least a portion of at least one behavioral fingerprint in accordance with certain example embodiments.

FIG. 3 is a schematic diagram illustrating an example behavioral fingerprint including one or more example indicators of one or more behavior-related acts in accordance with certain example embodiments.

FIG. 4 is a schematic diagram of an example user device including one or more example components in accordance with certain example embodiments.

FIG. 5 is a schematic diagram of an example server device including one or more example components in accordance with certain example embodiments.

FIGS. 6A and 6B are schematic diagrams of an example user device and an example server device, respectively, that have one or more functional units in accordance with certain example embodiments.

FIG. 7A is a schematic diagram that includes at least one example device that is capable of handling scenarios for behavioral fingerprinting via corroborative user device in accordance with certain example embodiments.

FIGS. 7B-7D are schematic diagrams that include at least one example device and that depict example scenarios for implementing behavioral fingerprinting via corroborative user device in accordance with certain example embodiments.

FIG. 8A is a flow diagram illustrating an example method for at least one device with regard to behavioral fingerprinting via corroborative user device in accordance with certain example embodiments.

FIGS. 8B-8F depict example additions or alternatives for a flow diagram of FIG. 8A in accordance with certain example embodiments.

FIGS. 9A-9D depict example additions or alternatives for a flow diagram of FIG. 8A in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

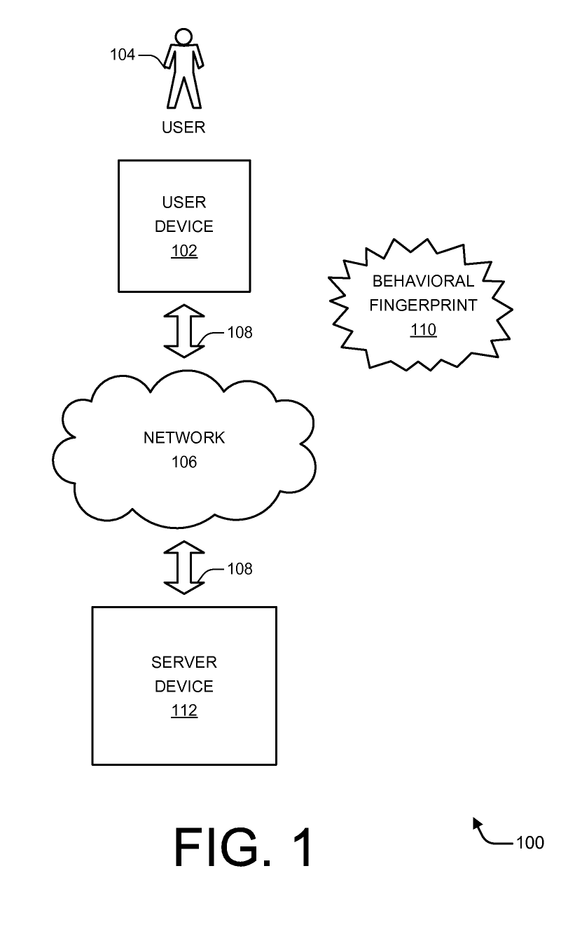

FIG. 1 is a schematic diagram 100 of a user device, a server device, and at least one behavioral fingerprint, any of which may be involved individually or jointly in example authentication scenarios in accordance with certain example embodiments. As shown in FIG. 1, by way of example but not limitation, schematic diagram 100 may include at least one user device 102, at least one user 104, at least one network 106, at least one channel 108, at least one behavioral fingerprint 110, or at least one server device 112. More specifically, at least one channel 108 may extend from or lead to a device 102 or 112 to facilitate communication therewith.

For certain example embodiments, a user 104 may correspond to or be utilizing at least one user device 102. A user 104 may utilize a user device 102 in accordance with a usage that may be at least partially represented by, modeled by, incorporated into, stored at, tracked by, summarized in, a combination thereof, etc. at least one behavioral fingerprint 110. A user device 102 may comprise, by way of example but not limitation, a mobile phone, a smart phone, a mobile terminal, a laptop or notebook computer, a personal digital assistant (PDA), a netbook, an entertainment appliance (e.g., a television, a gaming console, a set-top box, a music player, a combination thereof, etc.), a portable gaming device, a user equipment, a tablet or slate computer, a desktop computer, a personal navigation device (PND), a vehicle with user-accessible computational capabilities, videoconferencing equipment, some combination thereof, or so forth. A user 104 may comprise, by way of example only, at least one person, a couple, siblings, a family, a partnership, an organizational group, a company, a robotic user (e.g., a computational entity), an electronic agent, a portion thereof, some combination thereof, or so forth. However, claimed subject matter is not limited to any particular described embodiments, implementations, examples, etc.

For certain example embodiments, a network 106 may comprise, by way of example but not limitation, at least a portion of one or more networks having one or more nodes that transmit, receive, forward, generate, buffer, store, route, switch, process, a combination thereof, etc. one or more messages, packets, signals, waves, voltage or current levels, some combination thereof, or so forth. A network may comprise, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof, or so forth. A node may comprise, by way of example but not limitation, a server; a router; an end user device, such as a mobile phone, a tablet computer, a desktop computer, an entertainment appliance, a vehicle, a combination thereof, etc.; a switch; a base station; a gateway; some combination thereof; or so forth. However, claimed subject matter is not limited to any particular described embodiments, implementations, examples, etc.

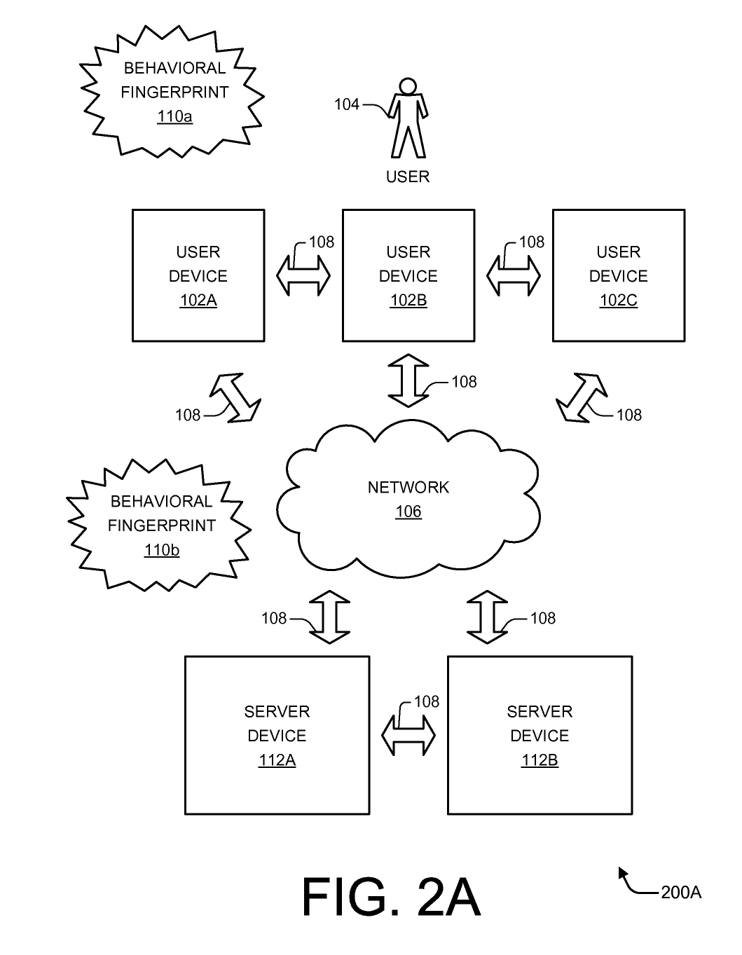

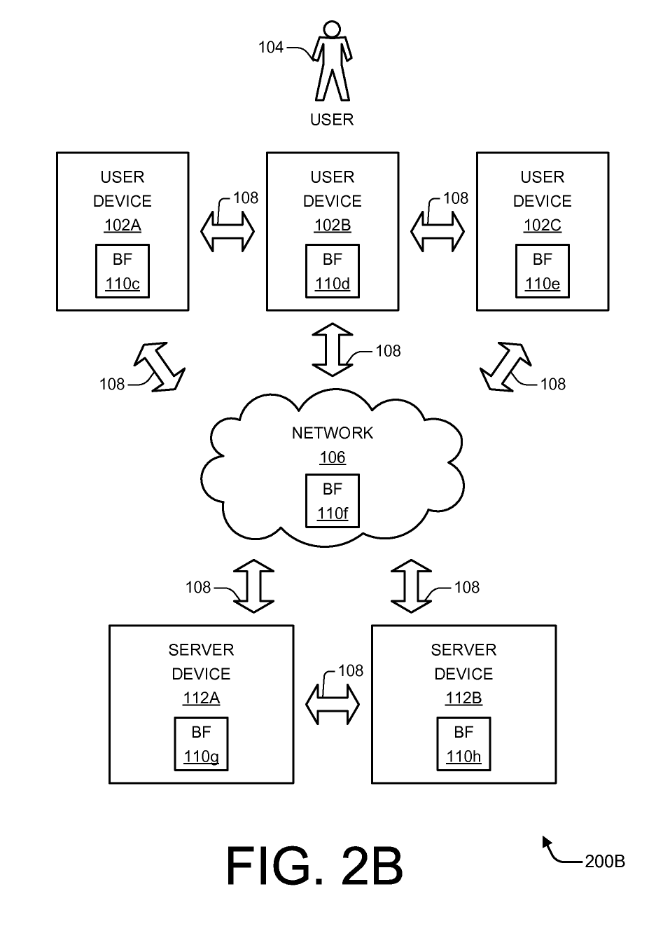

For certain example embodiments, a channel 108 may comprise, by way of example but not limitation, one or more of: at least one wired link, at least one wireless link, at least part of public network, at least part of a private network, at least part of a packet-switched network, at least part of a circuit-switched network, at least part of an infrastructure network, at least part of an ad hoc network, at least part of a PSTN, at least part of a cable network, at least part of a cellular network connection, at least part of an Internet connection, at least part of a Wi-Fi connection, at least part of a WiMax connection, at least part of an internet backbone, at least part of a satellite network, at least part of a fiber optic network, multiple instances of any of the above, one or more network nodes, some combination of the above, or so forth. A channel 108 may include one or more nodes (e.g., a telecommunication node, an access point, a base station, an internet server, a gateway, an internet or telecommunications switch, a combination thereof, etc.) through which signals are propagated. A communication may comprise, by way of example but not limitation, a transmission of data, a reception of data, an exchange of data, a flow of data (e.g., between or among two or more intermediate nodes or endpoints), some combination thereof, or so forth. A user device 102 may communicate with a server device 112, or vice versa, via one or more signals (not explicitly shown) using one or more channels 108. A couple of examples of channels 108 are illustrated in schematic diagram 100 (as well as in additional figures, such as schematic diagram 200A of FIG. 2A). Signals may propagate via one or more channels 108. Signals, by way of example but not limitation, may comprise, electrical signals, magnetic signals, electromagnetic signals, photonic signals, wireless signals, wired signals, multiples ones thereof, some combination thereof, or so forth. However, claimed subject matter is not limited to any particular described embodiments, implementations, examples, etc.

For certain example embodiments, a server device 112 may comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, or so forth. However, claimed subject matter is not limited to any particular described embodiments, implementations, examples, etc.

For certain example embodiments, at least one behavioral fingerprint 110 may comprise, by way of example but not limitation, one or more indicators representing one or more behaviors of at least one user with respect to at least one user device. Examples of one or more indicators representing one or more behaviors of at least one user with respect to at least one user device may include, but are not limited to, one or more indicators representing one or more habits of at least one user with respect to at least one user device, one or more indicators representing usage of at least one user device by at least one user, one or more indicators representing one or more actions of at least one user with respect to at least one user device, some combination thereof, or so forth. Additionally or alternatively, at least one behavioral fingerprint 110 may comprise, by way of example but not limitation, one or more indicators representing one or more predicted acts (e.g., behaviors, such as habits, usages, actions, a combination thereof, etc.) of at least one user with respect to at least one device. Additionally or alternatively, at least one behavioral fingerprint 110 may comprise, by way of example but not limitation, at least one status of a user that is utilizing or that corresponds to a user device. For certain example implementations, a user whose behavior is being monitored to at least partially establish at least a portion of at least one behavioral fingerprint 110 may comprise an authorized user, which is described herein below. However, claimed subject matter is not limited to any particular described embodiments, implementations, examples, etc.

For certain example embodiments, a user may be utilizing a user device, by way of example but not limitation, if the user is accessing the user device, if the user is interacting with the user device, if the user is carrying the user device, if the user is providing input to the user device, if the user is receiving output from the user device, if the user is directing operation of the user device, some combination thereof, or so forth. A user may correspond to a user device, by way of example but not limitation, if the user is an authorized user of the user device. However, claimed subject matter is not limited to any particular described embodiments, implementations, examples, etc.

For certain example embodiments, a user 104 of a user device 102 may comprise an authorized user of the user device 102: if the user 104 comprises, by way of example but not limitation, a true owner, a manager, an information technology (IT) specialist, a controller, a purchaser, a lessee, an approved borrower, a primary user, a combination thereof, etc. of the user device 102; if the user 104 is or has been authorized by a true owner, a manager, an IT specialist, a controller, a purchaser, a lessee, an approved borrower, a primary user, a combination thereof, etc. of the user device 102; some combination thereof; or so forth. In certain example implementations, a determination that a user 104 comprises (e.g., is, is becoming, is being designated, a combination thereof, etc.) an authorized user of a user device 102: may be effectuated if or when a user first registers a profile, an account, a combination thereof, etc. on a device (e.g., after a purchase or a ‘hard’ reset); may be effectuated if or when one or more ‘sign-ins’ (e.g., entry of a password, code, PIN, pattern, biometric input, a combination thereof, etc.) are performed by a user; may be effectuated if or when one or more user ID/secret information combinations (e.g., entry of an account name, email address, individualized identification, a combination thereof, etc. along with a corresponding password, code, PIN, pattern, biometric input, a combination thereof, etc.) are entered by a user; may be effectuated if or when a given user is identified as, designated as, or otherwise indicated to comprise an authorized user by one who is already an authorized user; some combination of such authorized user determinations; or so forth. An authorized user may add a new authorized user, by way of example only: by providing a name or other identification of another user or his or her biometric information (e.g., a facial photo, a voice sample, a fingerprint image, a retinal scan, a combination thereof, etc.); by providing a name or other identification of a user or temporary or permanent secret information, such as a password, a code, a PIN, a pattern, biometric input, a combination thereof, etc. (e.g., that a newly authorized user may be capable of changing or confirming); some combination thereof; or so forth. An authorized user, such as a true owner or IT specialist, may be empowered to remove someone from a list of authorized user(s). In certain example embodiments, different authorized users may have different levels of authorization (e.g., different levels of access, capabilities, rights, privileges, a combination thereof, etc.) with respect to a given user device 102. For certain example implementations, but by way of example only, one authorized user may comprise an administrator with full access rights or privileges, yet another authorized user may comprise a regular, non-administrative, or junior user with fewer access rights or privileges. Additionally or alternatively, one authorized user may have full access rights to applications and content stored on a device or associated with a particular account/profile, yet another authorized user may have restricted access rights to applications or content stored on a device such that access is prevented, for instance, to particular device settings or adult content. Other approaches to providing different levels of authorization may also or instead be implemented. By way of example only, an authorized user who is a true owner may add a new authorized user that is permitted to utilize existing applications and content but is prohibited from adding new applications or making particular purchases (e.g., individual purchases above a predetermined dollar amount or multiple purchases beyond a total dollar amount).

FIG. 2A is a schematic diagram 200A of multiple user devices, multiple server devices, and at least one behavioral fingerprint, any of which may be involved individually or jointly in example authentication scenarios in accordance with certain example embodiments. As shown in FIG. 2A, by way of example but not limitation, schematic diagram 200A may include at least one user device 102, at least one user 104, at least one network 106, at least one channel 108, at least one behavioral fingerprint 110, or at least one server device 112. More specifically, schematic diagram 200A may include, by way of example only, three user devices 102 (e.g., a user device 102A, a user device 102B, or a user device 102C, etc.), two server devices 112 (e.g., a server device 112A, or a server device 112B, etc.), or two behavioral fingerprints 110 (e.g., a behavioral fingerprint 110a, or a behavioral fingerprint 110b, etc.).

For certain example embodiments, a user 104 may correspond to or be utilizing multiple user devices 102, such as at least two of user device 102A, user device 102B, or user device 102C, at least partially simultaneously or from time to time. By way of example only, a user 104 may own at least two of: a mobile phone, a tablet computer, a vehicle with an intelligent computing apparatus, a laptop computer, or a desktop computer. For certain example implementations, at least part of a combined behavioral fingerprint 110 (e.g., a behavioral fingerprint 110a/110b) may be associated with a user 104 and each corresponding user device 102. Additionally or alternatively, an individualized behavioral fingerprint 110 (e.g., a behavioral fingerprint 110a or a behavioral fingerprint 110b) may be associated with a user 104 and each corresponding individual or respective user device 102. However, claimed subject matter is not limited to any particular described embodiments, implementations, examples, etc.

For certain example embodiments, a behavioral fingerprint 110, 110a, or 110b; an at least partially combined instantiation of at least two of a behavioral fingerprint 110, 110a, or 110b; a portion of a behavioral fingerprint 110, 110a, or 110b; a combination thereof; etc. may be distributed across or stored at, by way of example only, one or more of: a user device 102A, a user device 102B, a user device 102C, a network 106 or node thereof, a server device 112A, a server device 112B, some combination thereof, or so forth. Additionally or alternatively, a behavioral fingerprint 110, 110a, or 110b; an at least partially combined instantiation of at least two of a behavioral fingerprint 110, 110a, or 110b; a portion of a behavioral fingerprint 110, 110a, or 110b; a combination thereof; etc. may be transmitted, received, exchanged, a combination thereof, etc., by way of example only, via one or more of: at least one network 106, one or more channels 108, some combination thereof, or so forth. A user device 102 or a server device 112 may transmit, receive, exchange, a combination thereof, etc. at least a portion of a behavioral fingerprint 110, 110a, or 110b directly between or among devices 102 or 112 or indirectly via at least one node (not explicitly shown) of one or more networks 106. However, claimed subject matter is not limited to any particular described embodiments, implementations, examples, etc.

FIG. 2B is a schematic diagram 200B of multiple user devices, multiple server devices, and multiple example locations for at least a portion of at least one behavioral fingerprint in accordance with certain example embodiments. As shown in FIG. 2B, by way of example but not limitation, schematic diagram 200B may include at least one user device 102, at least one user 104, at least one network 106, at least one channel 108, at least one behavioral fingerprint 110, or at least one server device 112. More specifically, schematic diagram 200B may include, by way of example only, three user devices 102 (e.g., a user device 102A, a user device 102B, or a user device 102C, etc.), two server devices 112 (e.g., a server device 112A, or a server device 112B, etc.), or six behavioral fingerprints 110 (e.g., a behavioral fingerprint 110c, a behavioral fingerprint 110d, a behavioral fingerprint 110e, a behavioral fingerprint 110f, a behavioral fingerprint 110g, or a behavioral fingerprint 110h, etc.).

For certain example embodiments, a given behavioral fingerprint 110 or portion thereof may be located at (stored at, distributed at least partially across, accessible from, associated with, a combination thereof, etc.) one or more devices 102 or 112. By way of example only, a behavioral fingerprint 110c may be located at a user device 102A, a behavioral fingerprint 110d may be located at a user device 102B, a behavioral fingerprint 110e may be located at a user device 102C, a behavioral fingerprint 110f may be located at a network 106 (e.g., at a cloud service or system), a behavioral fingerprint 110g may be located at a server device 112A, or a behavioral fingerprint 110h may be located at a server device 112B. For certain example implementations, any one or more of behavioral fingerprints 110c-110h may comprise one or more separate or individualized behavioral fingerprints 110; may comprise one or more combined, amalgamated, distributed, a combination thereof, etc. behavioral fingerprints 110; may comprise at least a portion of at least one behavioral fingerprint 110; some combination thereof; or so forth. However, claimed subject matter is not limited to any particular described embodiments, implementations, examples, etc.

For certain example embodiments, at least one behavioral fingerprint 110 (e.g., of behavioral fingerprints 110c-110h) may be associated with at least one user 104 or one or more of user devices 102A, 102B, or 102C. For certain example implementations, a behavioral fingerprint 110c, which may be stored at a user device 102A, may be associated with a user 104 and user device 102A. For certain example implementations, a behavioral fingerprint 110g, which may be stored at a server device 112A, may be associated with a user 104 and a user device 102A. For certain example implementations, a behavioral fingerprint 110h, which may be stored at a server device 112B, may be associated with a user 104, a user device 102B, and a user device 102C. For certain example implementations, a behavioral fingerprint 110c, which may be stored at a user device 102A and associated therewith, and a behavioral fingerprint 110d, which may be stored at a user device 102B and associated therewith, may be individually or jointly associated with a user 104. A behavioral fingerprint 110c and a behavioral fingerprint 110d may be identical to each other, partially the same, different from one another, updated to keep one at least partially coherent or consistent with the other, some combination thereof, or so forth. For certain example implementations, a behavioral fingerprint 110d, which may be stored at a user device 102B and associated therewith, and a behavioral fingerprint 110g, which may be stored at a server device 112A and associated with a user device 102C, may be individually or jointly associated with a user 104. A behavioral fingerprint 110d and a behavioral fingerprint 110g may be identical to each other, partially the same, different from one another, updated to keep one at least partially coherent or consistent with the other, some combination thereof, or so forth. For certain example implementations, a behavioral fingerprint 110e, which may be stored at a user device 102C and associated therewith, and a behavioral fingerprint 110h, which may be stored at a server device 1126 and also associated with user device 102C, may be individually or jointly associated with a user 104. A behavioral fingerprint 110e and a behavioral fingerprint 110h may be identical to each other, partially the same, different from one another, updated to keep one at least partially coherent or consistent with the other, some combination thereof, or so forth. For certain example implementations, a behavioral fingerprint 110e, which may be stored at a user device 102C, may be associated with a user 104 and a user device 1026. Although each user device 102 and server device 112 (and network 106) is shown in schematic diagram 200B as having a behavioral fingerprint 110 located there at, one or more user devices 102 or server devices 112 (or networks 106) may alternatively not have a behavioral fingerprint 110 located there at. Furthermore, other additional or alternative approaches may instead be implemented.

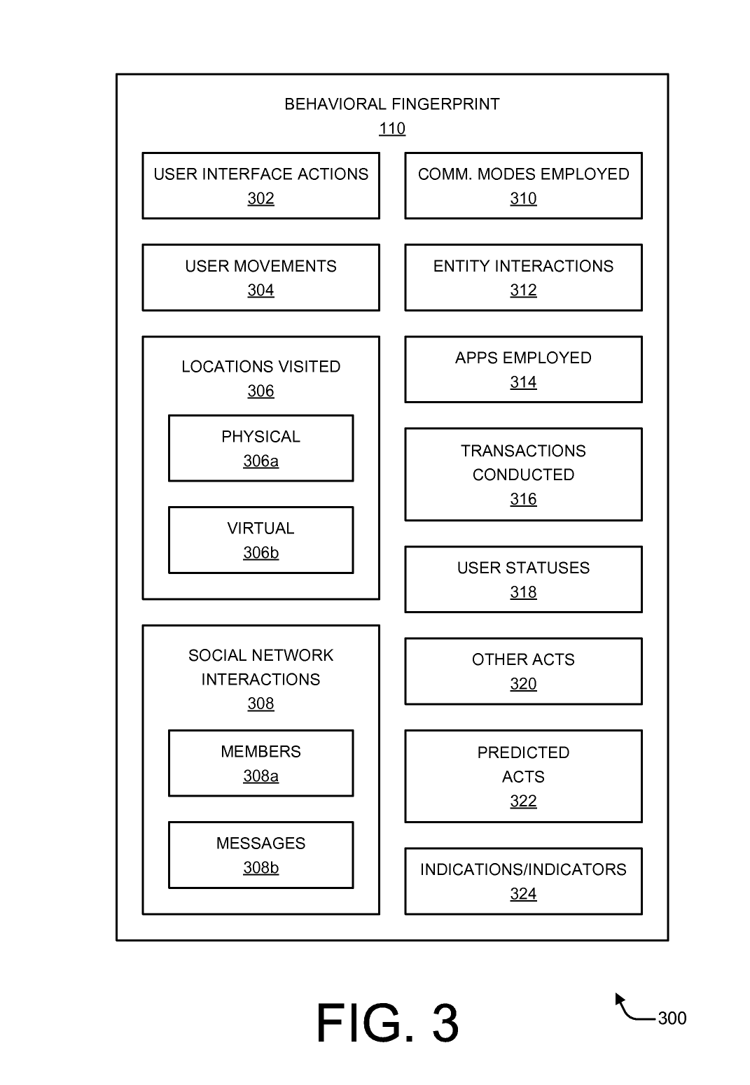

For certain example embodiments, a behavioral fingerprint 110 (including but not limited to any one or more of behavioral fingerprints 110a-110h) may comprise a whole behavioral fingerprint, a portion of a behavioral fingerprint, a behavioral fingerprint associated with a single user device, a behavioral fingerprint associated with multiple user devices, a part of a distributed behavioral fingerprint, a whole behavioral fingerprint that is distributed across multiple devices, a portion or a whole behavioral fingerprint that is located at one device, one or more indicators of one or more behavior-related acts, some combination thereof, or so forth. Examples of behavioral fingerprint(s) 110 are described further herein below with particular reference to FIG. 3. However, claimed subject matter is not limited to any particular described embodiments, implementations, examples, etc.

FIG. 3 is a schematic diagram 300 illustrating an example behavioral fingerprint including one or more example indicators of one or more behavior-related acts in accordance with certain example embodiments. As shown in FIG. 3, by way of example but not limitation, schematic diagram 300 may comprise a behavioral fingerprint 110, which behavioral fingerprint 110 may include any one or more of indications of various acts 302-322 or other indications 324. Example indications 302-324 that are illustrated may include, but are not limited to, user interface actions 302, user movements 304, locations visited 306, social network interactions 308, communication modes employed 310, entity interactions 312, apps employed 314, transactions conducted 316, user statuses 318, other acts 320, predicted acts 322, other indications or indicators 324, some combination thereof, or so forth. More specifically, locations visited 306 may include physical locations visited 306a, virtual locations visited 306b, a combination thereof, etc., or social network interactions 308 may include social network members 308a, social network messages 308b, a combination thereof, etc. Additional or alternative implementations to those of schematic diagram 300 for a behavioral fingerprint 110 are described further herein below as well as above. Moreover, a behavioral fingerprint 110 may alternatively include more, fewer, or different indication(s) from those that are illustrated without departing from claimed subject matter.

For certain example embodiments, one or more user interface actions 302 may include, but are not limited to, a type of user interaction (e.g., buttons, keys, physical keyboard, touch screen, swipes, virtual buttons, virtual keyboard, multi-finger touch, speech, textual, movement sensing input such as a shake or a twist, a combination thereof, etc.), a speed of user interaction (e.g., speech rate, speech cadence, typing speed, swiping speed, scrolling speed, speed moving between or among windows or apps, duration of a swipe or press of a virtual or physical key or button, a combination thereof, etc.), a user input apparatus (e.g., a built-in microphone, a wireless microphone, a built-in keyboard, a virtual keyboard, a detachable/attachable keyboard, a wireless keyboard, an input apparatus identifiable such as by name or number, a combination thereof, etc.), a position of user interaction (e.g., a location of touch for a touch-sensitive screen having a keyboard or button or swipe area, a location of a swipe, a length of a swipe, an offset from a designated key or slide area, a combination thereof, etc.), a user output apparatus (e.g., a screen, a built-in speaker, a separate speaker, a vibration unit, an integrated output apparatus, a wired output apparatus, a wireless output apparatus, an output apparatus identifiable such as by name or number, a combination thereof, etc.), some combination thereof, or so forth. However, claimed subject matter is not limited to any particular described embodiments, implementations, examples, etc.

For certain example embodiments, one or more user movements 304 may include, but are not limited to, device orientation (e.g., cardinal direction a device is pointed at, angle a device is held at, a combination thereof, etc.), device shakes or deformations (e.g., how a device is moved to provide input, how a device is pressed or twisted or curved to provide input, a combination thereof, etc.), a pattern of vibrations or jostling applied to or experienced by a device during daily use (e.g., as a result of carrying it, commuting with it, placing it in a pack or purse, placing it in a pocket, a combination thereof, etc.), some combination thereof, or so forth. However, claimed subject matter is not limited to any particular described embodiments, implementations, examples, etc.

For certain example embodiments, one or more locations visited 306 may include, but are not limited to, locations that a user carries, sends, places, or travels with a device; locations that a user directs software to acquire data from or send data to; some combination thereof; or so forth. For certain example implementations, physical locations visited 306a may include, but are not limited to, an address, a room, a store, a building, a neighborhood, a city, a state, a country, one or more satellite positioning system (SPS) coordinates, a check-in location, a business, one or more geographical (e.g., cardinal) coordinates, a geographical zone (e.g., coordinates or approximate position in conjunction with a distance or range), some combination thereof, or so forth. For certain example implementations, virtual locations visited 306b may include, but are not limited to, an internet address, a web page, a web site, a social network, a destination within a social network, a virtual world, a destination within a virtual world, a chat room, a bulletin board, a blog, some combination thereof, or so forth. However, claimed subject matter is not limited to any particular described embodiments, implementations, examples, etc.

For certain example embodiments, one or more social network interactions 308 may include, but are not limited to, accessing a social network, reading a communication from one or more social network members, sending a communication to one or more social network members, changing profile or account information for a social network, viewing publicly-available social network information (e.g., viewing a person's wall, board, stream, pinning, a combination thereof, etc.), viewing private social network information (e.g., viewing a targeted or personalized message, tweet, picture, a combination thereof, etc.), searching for entities on a social network, playing games via a social network, experiencing entertainment (e.g., video, audio, clips, pictures, a combination thereof, etc.) via a social network, a listing of which social network(s) are accessed, an order of which social networks are accessed, a day or time of accessing particular social network(s), some combination thereof, or so forth. For certain example implementations, social network member interactions 308a may include, but are not limited to, identifying or listing members interacted with via receiving, retrieving, sending, replying to a combination thereof, etc. one or more communications; noting particular social network protocols or modes (e.g., wall writing or viewing, tweet sending or receiving, picture sending or viewing, public versus private communicating, a combination thereof, etc.) used to communicate with particular members individually or in groups; noting particular social network protocols or modes used to communicate with particular member groups; some combination thereof; or so forth. For certain example implementations, social network message interactions 308b may include, but are not limited to, noting (e.g., recording, memorializing, storing, identifying, a combination thereof, etc.) messages sent or received, noting an order of message sending or viewing, noting a type (e.g., a social network protocol) of message sent or received, noting a number of messages sent or received, noting a duration between arrival of a message (e.g., generally or from a particular member) and viewing of the message, noting a duration between arrival or viewing of a message (e.g., generally or from a particular member) and responding to the message, some combination thereof, or so forth. However, claimed subject matter is not limited to any particular described embodiments, implementations, examples, etc.

For certain example embodiments, one or more communication modes employed 310 may include, but are not limited to, speech, a phone call, a voice-over-internet-protocol (VoIP) communication, text messaging, instant messaging, a video communication (e.g., a video call, a video conference, a combination thereof, etc.), a social-network-based communication (e.g., a communication that is effectuated at least partially using a social network app, web site, service, a combination thereof, etc.), some combination thereof, or so forth. Additionally or alternatively, one or more communication modes employed 310 may include, but are not limited to, indications of which communication mode is employed if/when responding to a received communication of a given communication mode (e.g., it may be noted that an authorized user may respond to most phone calls or phone calls from particular people with text messages). However, claimed subject matter is not limited to any particular described embodiments, implementations, examples, etc.

For certain example embodiments, one or more entity interactions 312 may include, but are not limited to, identification of at least one entity (e.g., business, service, person, social network member, group, organization, a combination thereof, etc.) that a user interacts with (e.g., with or without an indication of a communication mode, such as via a telephone capability, via email, via instant messaging, via a social network communication protocol, via VoIP, via a video capability, via a speech capability, a combination thereof, etc.), a listing of entities interacted with, an order of entities interacted with, notations of when (e.g., a day, a time, days of week, a combination thereof, etc.) entities are interacted with, notations of how (e.g., a communication mode used, a duration, a combination thereof, etc.) entities are interacted with, some combination thereof, or so forth. However, claimed subject matter is not limited to any particular described embodiments, implementations, examples, etc.

For certain example embodiments, one or more apps employed 314 may include, but are not limited to, identification of one or more apps (e.g., applications, native applications, downloaded applications, installed applications, software applications, web applications, a combination thereof, etc.) employed (e.g., accessed, started, opened, launched, viewed, consulted, manipulated, configured, installed, executed, a combination thereof, etc.) by a user, a listing of apps employed, an order of apps employed, a notation of a time or a day at which apps are employed, a notation of duration(s) for which apps are employed, some combination thereof, or so forth. However, claimed subject matter is not limited to any particular described embodiments, implementations, examples, etc.

For certain example embodiments, one or more transactions conducted 316 may include, but are not limited to, an identification of transactions (e.g., exchanges of consideration, purchases, orders, downloads, a combination thereof, etc.) conducted (e.g., initiated, requested, consummated, effectuated, accomplished, monitored, a combination thereof, etc.), a list of transactions, a notation of times or days of transactions, a notation of transaction amounts, a notation of at least one party to one or more transactions, a notation of items (e.g., physical items such as food or electronics, virtual items such as songs or movies or games or in-game abilities, a combination thereof, etc.) or services (e.g., physical services such as a massage or a car wash, virtual services such as streaming media or a membership, a combination thereof, etc.) involved in one or more transactions, some combination thereof, or so forth. However, claimed subject matter is not limited to any particular described embodiments, implementations, examples, etc.

For certain example embodiments, one or more user statuses 318 may include, but are not limited to, a location status update, a health status update, an alert (e.g., as to whether a person has possession or has lost possession of a device; as to whether a device has exceeded some percentage—e.g. 50% or 75% or 100%—of an allotted amount, such as of minutes of talking, bytes of data, messages of texting, dollars of a fund, time of use, etc.; as to where a person is currently located; a combination thereof; etc.), a current (e.g., most recent, present, a combination thereof, etc.) activity update, some combination thereof, or so forth. However, claimed subject matter is not limited to any particular described embodiments, implementations, examples, etc.

For certain example embodiments, one or more other acts 320 may include, but are not limited to, other user behaviors, user habits, user actions, user movements, user interactions, user visitations, user transactions, device features (e.g., capabilities, native applications, operating system functions, a combination thereof, etc.) employed, a combination thereof, etc. that a device may monitor (e.g., detect, observe, discern, ascertain, a combination thereof, etc.); other acts reflecting user behavior; other acts described herein; some combination thereof; or so forth. However, claimed subject matter is not limited to any particular described embodiments, implementations, examples, etc.

For certain example embodiments, one or more predicted acts 322 may include, but are not limited to, an act that is predicted based at least partially on any one or more of other indications 302-320; an act that is predicted to be performed by an authorized user; an act corresponding to a particular likelihood level of re-occurring; an act that is predicted to re-occur in view of one or more observed acts of at least one authorized user of one or more user devices; an act that is predicted to occur based at least partially on a statistical analysis (e.g., a likelihood function, a histogram evaluation, a probabilistic approach, a Bayesian analysis, a stochastic mechanism, a correlation procedure, a probability density function, a normal/Gaussian distribution, a cumulative distribution function, an expected value, a combination thereof, etc.) of one or more historically-monitored acts; an act that has been repeatedly performed in certain manner(s) or at particular time(s) such that it can be expected to be performed again in such certain manner(s) or at such particular time(s); an act that is derived or results from a conversion of monitored act(s) corresponding to one device to at least one act corresponding to another device; some combination thereof; or so forth. However, claimed subject matter is not limited to any particular described embodiments, implementations, examples, etc.

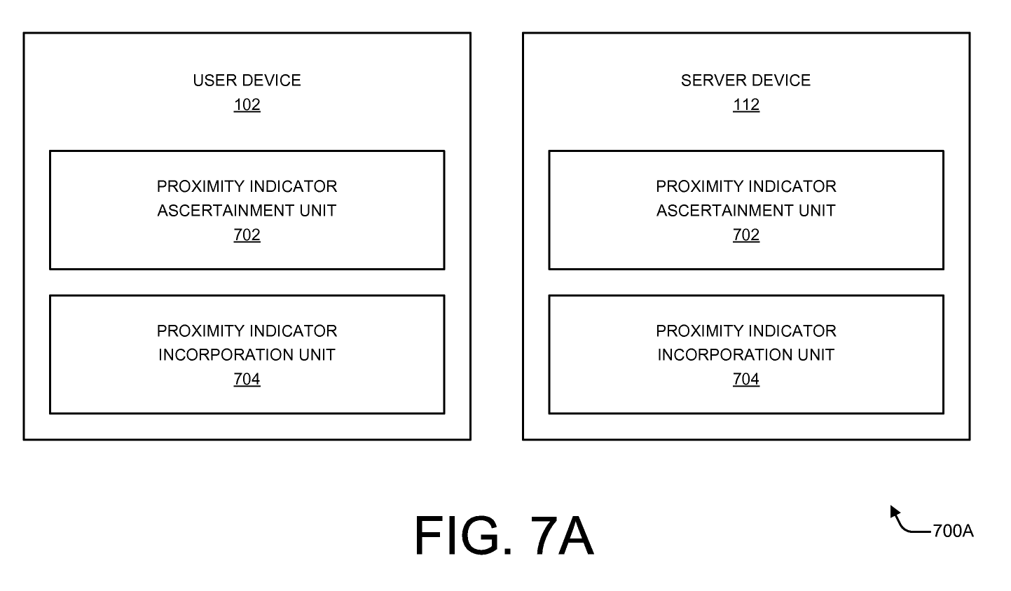

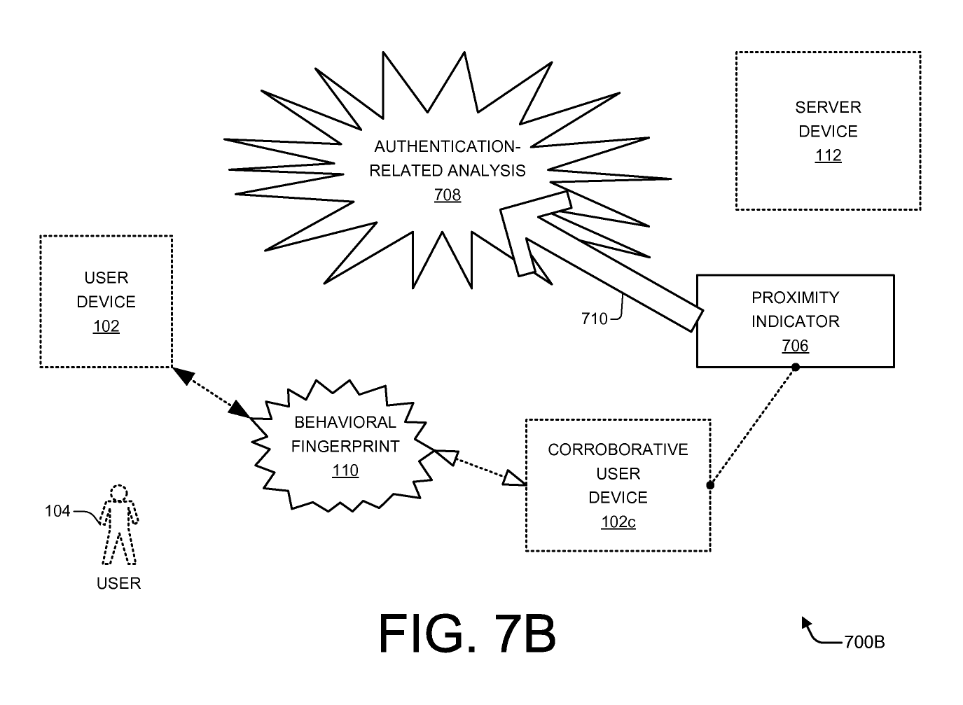

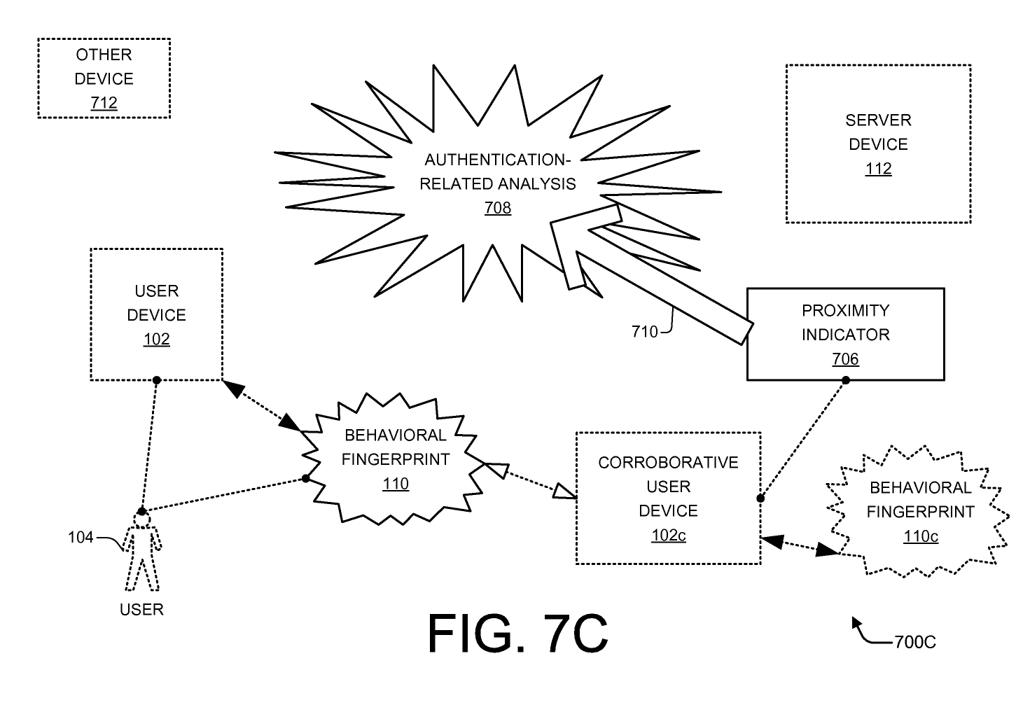

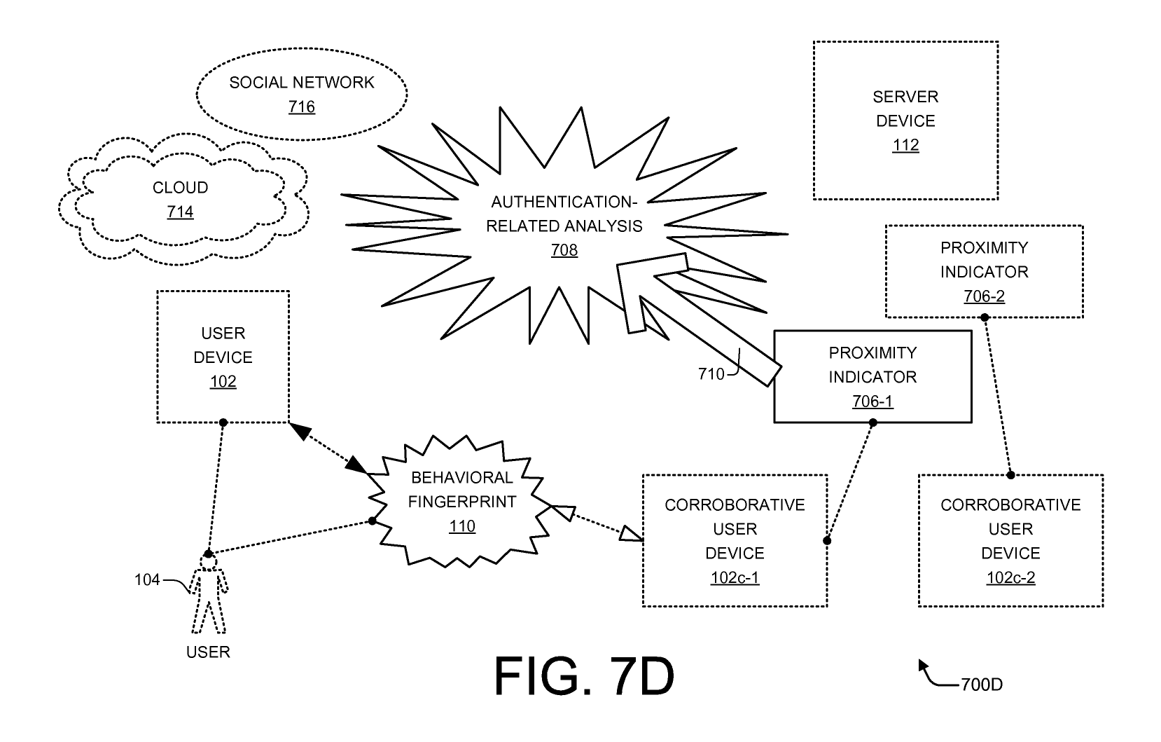

For certain example embodiments, one or more other indications 324 may include, but are not limited to, static characteristics of an authorized user, individuals that are related to an authorized user, characteristics of individuals that are related to an authorized user; nature of relationships between or among an authorized user and other individuals, some combination thereof, or so forth. Non-exhaustive examples of other indications or indicators 324 are provided herein below with particular reference to FIGS. 7A-7C, 8A-8M, and 9A-9G. However, claimed subject matter is not limited to any particular described embodiments, implementations, examples, etc.

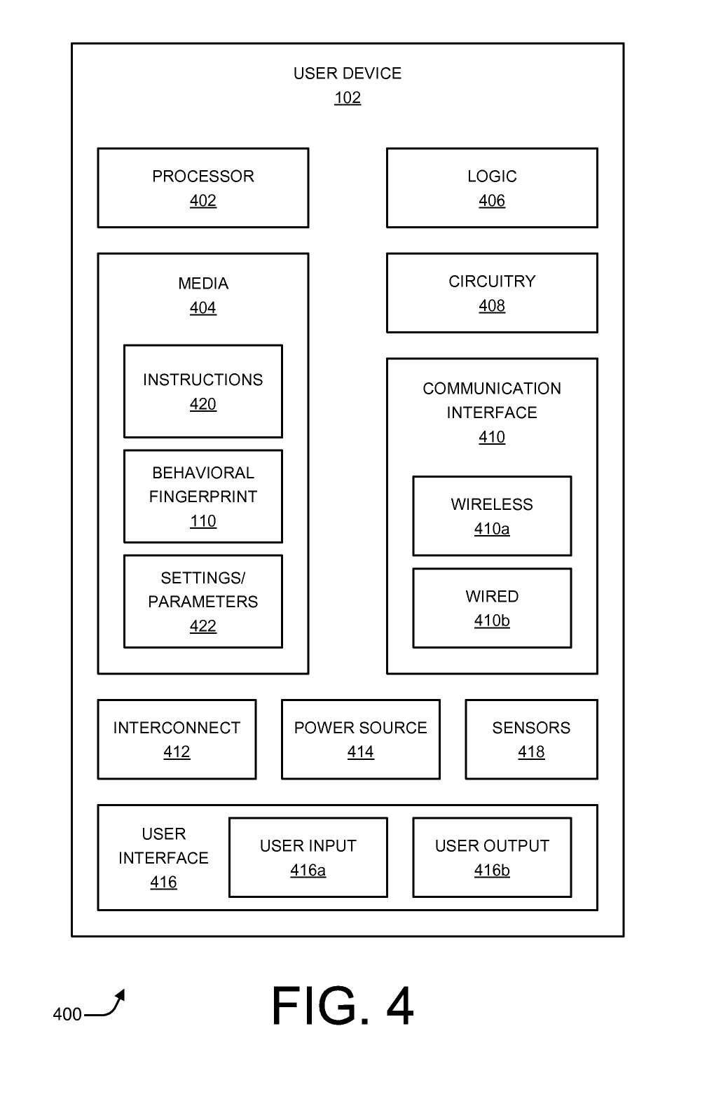

FIG. 4 is a schematic diagram 400 of an example user device including one or more example components in accordance with certain example embodiments. As shown in FIG. 4, a user device 102 may include one or more components such as: at least one processor 402, one or more media 404, logic 406, circuitry 408, at least one communication interface 410, at least one interconnect 412, at least one power source 414, at least one user interface 416, one or more sensors 418, some combination thereof, or so forth. Furthermore, as shown in schematic diagram 400, one or more media 404 may comprise one or more instructions 420, at least one behavioral fingerprint 110, one or more settings or parameters 422, some combination thereof, or so forth; a communication interface 410 may comprise at least one wireless communication interface 410a, at least one wired communication interface 410b, some combination thereof, or so forth; or a user interface 416 may comprise at least one user input interface 416a, at least one user output interface 416b, some combination thereof, or so forth. However, a user device 102 may alternatively include more, fewer, or different component(s) from those that are illustrated without departing from claimed subject matter.

For certain example embodiments, a user device 102 may include or comprise at least one electronic device. User device 102 may comprise, for example, a computing platform or any electronic device having at least one processor or memory. Processor 402 may comprise, by way of example but not limitation, any one or more of a general-purpose processor, a specific-purpose processor, a digital signal processor (DSP), a processing unit, some combination thereof, or so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, some combination thereof, or so forth. Media 404 may bear, store, contain, include, provide access to, a combination thereof, etc. instructions 420, which may be executable by a processor 402; at least one behavioral fingerprint 110; one or more settings/parameters 422; some combination thereof; or so forth. Instructions 420 may comprise, by way of example but not limitation, a program, a module, an application or app (e.g., that is native, that runs in a browser, that runs within a virtual machine, a combination thereof, etc.), an operating system, a combination thereof, etc. or portion thereof; operational data structures; source code, object code, just-in-time (JIT) compiled code, a combination thereof, etc.; processor-executable instructions; other code; some combination thereof; or so forth. Media 404 may comprise, by way of example but not limitation, processor-accessible or non-transitory media (e.g., memory, random access memory (RAM), read only memory (ROM), flash memory, hard drives, disk-based media, disc-based media, magnetic storage, optical storage, volatile memory, nonvolatile memory, a combination thereof, etc.) that is capable of bearing instructions, a behavioral fingerprint, settings, parameters, some combination thereof, or so forth.

For certain example embodiments, execution of instructions 420 by one or more processors 402 may transform user device 102 into a special-purpose computing device, apparatus, platform, machine, some combination thereof, or so forth. Instructions 420 may comprise, for example, instructions that are capable of realizing at least a portion of one or more flow diagrams, methods, processes, procedures, operations, functionality, technology, mechanisms, a combination thereof, etc. that are described herein or illustrated in the accompanying drawings. Settings/parameters 422 may comprise, by way of example but not limitation, one or more settings or parameters that may be established or determined by a user or other entity, one or more or settings or parameters that may be determined or detected by a user device 102, one or more settings or parameters that may be received from another device that determined or detected them, one or more settings or parameters that may determine at least partly how a user device 102 is to operate or respond to a situation or a behavioral fingerprint, one or more settings or parameters (e.g., values) that may be used to realize flow diagrams, methods, processes, procedures, operations, functionality, technology, mechanisms, a combination thereof, etc. that are described herein or illustrated in the accompanying drawings. Settings/parameters 422 may control at least partially how at least one behavioral fingerprint 110 is configured, stored, shared, used, applied, some combination thereof, or so forth. Additionally or alternatively, at least a portion of settings/parameters 422 may be at least partially integrated with at least one behavioral fingerprint 110.

For certain example embodiments, logic 406 may comprise hardware, software, firmware, discrete/fixed logic circuitry, a combination thereof, etc. that is capable of performing or facilitating performance of flow diagrams, methods, processes, procedures, operations, functionality, technology, mechanisms, a combination thereof, etc. that are described herein or illustrated in the accompanying drawings. Circuitry 408 may comprise hardware, software, firmware, discrete/fixed logic circuitry, a combination thereof, etc. that is capable of performing or facilitating performance of flow diagrams, methods, processes, procedures, operations, functionality, technology, mechanisms, a combination thereof, etc. that are described herein or illustrated in the accompanying drawings, wherein circuitry 408 comprises at least one physical or hardware component or aspect.

For certain example embodiments, one or more communication interfaces 410 may provide one or more interfaces between user device 102 and another device or a person/operator. With respect to a person/operator, a communication interface 410 may include, by way of example but not limitation, a screen, a speaker, a keyboard or keys, a microphone, or other person-device input/output apparatuses. A wireless communication interface 410a or a wired communication interface 410b may also or alternatively include, by way of example but not limitation, a transceiver (e.g., a transmitter or a receiver), a radio, an antenna, a wired interface connector or other similar apparatus (e.g., a network connector, a universal serial bus (USB) connector, a proprietary connector, a Thunderbolt® or Light Peak® connector, a combination thereof, etc.), a physical or logical network adapter or port, a frequency converter, a baseband processor, a combination thereof, etc. to communicate wireless signals or wired signals via one or more wireless communication links or wired communication links, respectively, such as over at least one channel 108 (e.g., of FIGS. 1 and 2A). Communications with at least one communication interface 410 may enable transmitting, receiving, or initiating of transmissions, just to name a few examples.

For certain example embodiments, at least one interconnect 412 may enable signal communication between or among components of user device 102. Interconnect 412 may comprise, by way of example but not limitation, one or more buses, channels, switching fabrics, some combination thereof, or so forth. Although not explicitly illustrated in FIG. 4, one or more components of user device 102 may be coupled to interconnect 412 via a discrete or integrated interface. By way of example only, one or more interfaces may couple a communication interface 410 or a processor 402 to at least one interconnect 412. For certain example embodiments, at least one power source 414 may provide power to one or more components of user device 102. Power source 414 may comprise, by way of example but not limitation, a battery, a power connector, a solar power source or charger, a mechanical power source or charger, a fuel source, some combination thereof, or so forth.

For certain example embodiments, at least one sensor 418 may sense, produce, or otherwise provide at least one sensor value. Sensors 418 may include, by way of example only, a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), some combination thereof, or so forth. Values provided by at least one sensor 418 may comprise, by way of example but not limitation, an image, a sound recording, an acceleration value, a temperature, SPS coordinates, a barometric pressure, a humidity level, a compass direction, a gyroscopic value, a magnetic reading, a pressure value, an oscillation value, an ambient light reading, inertial readings, touch detections, finger placements, flex detections, some combination thereof, or so forth.

For certain example embodiments, a user interface 416 may enable one or more users to interact with user device 102. Interactions between a user and a user device may relate, by way of example but not limitation: to touch/tactile/feeling/haptic sensory (e.g., a user may shake, rotate, decline/incline, bend, twist, or move a user device which may be detected by a gyroscope, an accelerometer, a compass, a combination thereof, etc.; a user may press a button, slide a switch, rotate a knob, etc.; a user may touch a touch-sensitive screen; a device may vibrate; some combination thereof; or so forth), to sound/hearing/speech sensory (e.g., a user may speak into a microphone, a device may generate sounds via a speaker, a combination thereof, etc.), to sights/vision sensory (e.g., a device may activate one or more lights, modify an image presented on a display screen, a combination thereof, etc.), some combination thereof, or so forth.

For certain example embodiments, a user interface 416 may comprise a user input interface 416a, a user output interface 416b, some combination thereof, or so forth. A user input interface 416a may comprise, by way of example but not limitation, a microphone, a button, a switch, a dial, a knob, a wheel, a trackball, a key, a keypad, a keyboard, a touch-sensitive screen, a touch-sensitive surface, a camera, a gyroscope, an accelerometer, a compass, a virtual button/slider/keyboard/etc. presented on a touch-sensitive screen, some combination thereof, or so forth. A user output interface 416b may comprise, by way of example but not limitation, a speaker, a screen (e.g., with or without touch-sensitivity), a vibrating haptic feature, some combination thereof, or so forth. Certain user interfaces 416 may enable both user input and user output. For example, a touch-sensitive screen may be capable of providing user output and accepting user input. Additionally or alternatively, a user interface 416 component (e.g., that may be integrated with or separate from a user device 102), such as a headset that has a microphone and a speaker, may enable both user input and user output.

However, claimed subject matter is not limited to any particular described embodiments, implementations, examples, or so forth. For instance, it should be understood that for certain example implementations components that are illustrated separately in FIG. 4 may not necessarily be separate or mutually exclusive. For example, a given component may provide multiple functionalities. By way of example only, a single component such as a USB connector may function as a wired communication interface 410b or a power source 414. Additionally or alternatively, a single component such as a display screen may function as a communication interface 410 with respect to a user, as a user input interface 416a, or as a user output interface 416b. Additionally or alternatively, one or more instructions 420 may function to realize at least part of a behavioral fingerprint 110 or at least one setting or parameter 422.

It should also be understood that for certain example implementations components that are illustrated in schematic diagram 400 or described herein may or may not be integral with or integrated into a user device 102. For example, a component may be removably connected to a user device 102, a component may be wirelessly coupled to a user device 102, some combination thereof, or so forth. By way of example only, instructions 420 may be stored on a removable card having at least one medium 404. Additionally or alternatively, a user interface 416 (e.g., a wired or wireless headset, a screen, a video camera, a keyboard, a combination thereof, etc.) may be coupled to a user device 102 wirelessly or by wire. However, claimed subject matter is not limited to any particular described embodiments, implementations, examples, etc.

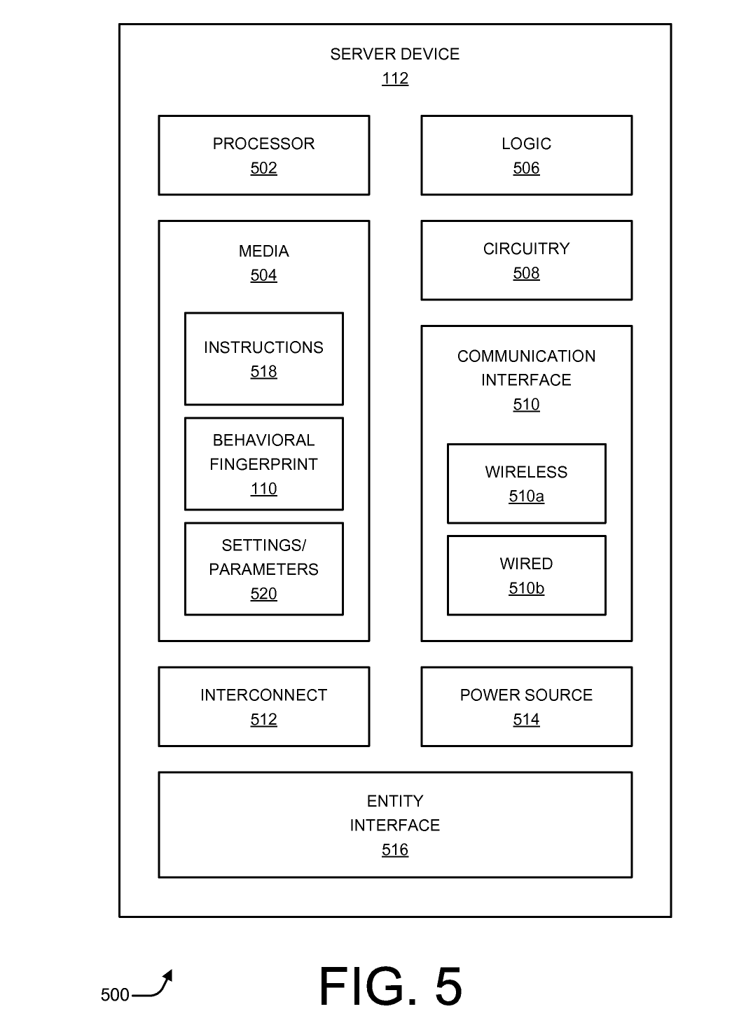

FIG. 5 is a schematic diagram 500 of an example server device including one or more example components in accordance with certain example embodiments. As shown in FIG. 5, a server device 112 may include one or more components such as: at least one processor 502, one or more media 504, logic 506, circuitry 508, at least one communication interface 510, at least one interconnect 512, at least one power source 514, at least one entity interface 516, some combination thereof, or so forth. Furthermore, as shown in schematic diagram 500, one or more media 504 may comprise one or more instructions 518, at least one behavioral fingerprint 110, one or more settings or parameters 520, some combination thereof, or so forth; or communication interface 510 may comprise at least one wireless communication interface 510a, at least one wired communication interface 510b, some combination thereof, or so forth. However, a server device 112 may alternatively include more, fewer, or different component(s) from those that are illustrated without departing from claimed subject matter.

For certain example embodiments, a server device 112 may include or comprise at least one processing or computing device or machine. Server device 112 may comprise, for example, a computing platform or any electronic device or devices having at least one processor or memory. Processor 502 may comprise, by way of example but not limitation, any one or more of a general-purpose processor, a specific-purpose processor, a digital signal processor (DSP), a processing unit, some combination thereof, or so forth. A processing unit may be implemented, for example, with one or more application specific integrated circuits (ASICs), DSPs, digital signal processing devices (DSPDs), programmable logic devices (PLDs), field programmable gate arrays (FPGAs), processors generally, processing cores, discrete/fixed logic circuitry, controllers, micro-controllers, microprocessors, some combination thereof, or so forth. Media 504 may bear, store, contain, include, provide access to, a combination thereof, etc. instructions 518, which may be executable by a processor 502; at least one behavioral fingerprint 110; one or more settings/parameters 520; some combination thereof; or so forth. Instructions 518 may comprise, by way of example but not limitation, a program, a module, an application or app (e.g., that is native, that runs in a browser, that runs within a virtual machine or server, a combination thereof, etc.), an operating system, a combination thereof, etc. or portion thereof; operational data structures; source code, object code, just-in-time (JIT) compiled code, a combination thereof, etc.; processor-executable instructions; other code; some combination thereof; or so forth. Media 504 may comprise, by way of example but not limitation, processor-accessible or non-transitory media (e.g., memory, random access memory (RAM), read only memory (ROM), flash memory, hard drives, disk-based media, disc-based media, magnetic storage, optical storage, volatile memory, nonvolatile memory, a combination thereof, etc.) that is capable of bearing instructions, at least one behavioral fingerprint, settings, parameters, some combination thereof, or so forth.

For certain example embodiments, execution of instructions 518 by one or more processors 502 may transform server device 112 into a special-purpose computing device, apparatus, platform, machine, some combination thereof, or so forth. Instructions 518 may comprise, for example, instructions that are capable of realizing at least a portion of one or more flow diagrams methods, processes, procedures, operations, functionality, technology, mechanisms, a combination thereof, etc. that are described herein or illustrated in the accompanying drawings. Settings/parameters 520 may comprise, by way of example but not limitation, one or more settings or parameters that may be established by a user or other entity, one or more settings or parameters that may be determined by a server device 112, one or more settings or parameters that may be determined by a user or other entity, one or more settings or parameters that may be detected by a server device 112, one or more settings or parameters that may be received from another device that detected them, one or more settings or parameters that may determine at least partly how a server device 112 is to operate or respond to a situation or a behavioral fingerprint, one or more settings or parameters (e.g., values) that may be used to realize flow diagrams, methods, processes, procedures, operations, functionality, technology, mechanisms, a combination thereof, etc. that are described herein or illustrated in the accompanying drawings. Settings/parameters 520 may control at least partially how at least one behavioral fingerprint 110 is configured, stored, shared, used, applied, some combination thereof, or so forth. Additionally or alternatively, at least a portion of settings/parameters 520 may be at least partially integrated with at least one behavioral fingerprint 110.

For certain example embodiments, logic 506 may comprise hardware, software, firmware, discrete/fixed logic circuitry, a combination thereof, etc. that is capable of performing or facilitating performance of flow diagrams, methods, processes, procedures, operations, functionality, technology, mechanisms, a combination thereof, etc. that are described herein or illustrated in the accompanying drawings. Circuitry 508 may comprise hardware, software, firmware, discrete/fixed logic circuitry, a combination thereof, etc. that is capable of performing or facilitating performance of flow diagrams, methods, processes, procedures, operations, functionality, technology, mechanisms, a combination thereof, etc. that are described herein or illustrated in the accompanying drawings, wherein circuitry 508 comprises at least one physical or hardware component or aspect.

For certain example embodiments, one or more communication interfaces 510 may provide one or more interfaces between server device 112 and another device or a person/operator/entity directly or indirectly. A wireless communication interface 510a or a wired communication interface 510b may also or alternatively include, by way of example but not limitation, a transceiver (e.g., a transmitter or a receiver), a radio, an antenna, a wired interface connector or other similar apparatus (e.g., a network connector, a universal serial bus (USB) connector, a proprietary connector, a Thunderbolt® or Light Peak® connector, a gateway, a combination thereof, etc.), a physical or logical network adapter or port, a frequency converter, a baseband processor, an Internet or telecommunications backbone connector, a fiber optic connector, a storage area network (SAN) connector, a combination thereof, etc. to communicate wireless signals or wired signals via one or more wireless communication links or wired communication links, respectively, such as over one or more channels 108 (e.g., of FIGS. 1 and 2A). Communications with at least one communication interface 510 may enable transmitting, receiving, or initiating of transmissions, just to name a few examples.

For certain example embodiments, at least one interconnect 512 may enable signal communication between or among components of server device 112. Interconnect 512 may comprise, by way of example but not limitation, one or more buses, channels, switching fabrics, local area networks (LANs), storage area networks (SANs), some combination thereof, or so forth. Although not explicitly illustrated in FIG. 5, one or more components of server device 112 may be coupled to interconnect 512 via a discrete or integrated interface. By way of example only, one or more interfaces may couple a processor 502 or a medium 504 to at least one interconnect 512. For certain example embodiments, at least one power source 514 may provide power to one or more components of server device 112. Power source 514 may comprise, by way of example but not limitation, a power connector for accessing an electrical grid, a fuel cell, a solar power source, some combination thereof, or so forth.

For certain example embodiments, an entity interface 516 may enable one or more entities (e.g., another device, a person, a group, a robotic entity, a combination thereof, etc.) to provide input to or receive output from server device 112. Interactions between an entity and a device may relate, by way of example but not limitation, to inputting or outputting instructions, commands, settings, parameters, indications, some combination thereof, or so forth. Certain entity interfaces 516 may enable both entity input and entity output at server device 112 or over at least one network link, such as one or more channels 108 (e.g., of FIGS. 1 and 2A).

However, claimed subject matter is not limited to any particular described embodiments, implementations, examples, or so forth. For instance, it should be understood that for certain example implementations components that are illustrated separately in FIG. 5 need not necessarily be separate or mutually exclusive. For example, a given component may provide multiple functionalities. By way of example only, hard-wired logic 506 may form circuitry 508. Additionally or alternatively, a single component such as a connector may function as a communication interface 510 or as an entity interface 516. Additionally or alternatively, one or more instructions 518 may function to realize at least one setting or parameter 520.

It should also be understood that for certain example implementations components that are illustrated in schematic diagram 500 or described herein may not be integral or integrated with a server device 112. For example, a component may be removably connected to a server device 112, a component may be wirelessly coupled to a server device 112, one or more components of a server device 112 may be geographically distributed or separated from one another, some combination thereof, or so forth. By way of example only, instructions 518 may be stored on one medium 504, and settings/parameters 520 (or another portion of instructions 518) may be stored on a different medium 504, which may comprise a same server or a part of a different server of, e.g., a server farm. Additionally or alternatively, respective processor-media sets may be physically realized on different or respective server blades or server containers. Multiple server blades, for instance, may be linked or interlinked to realize at least one server device 112. However, claimed subject matter is not limited to any particular described embodiments, implementations, examples, etc.

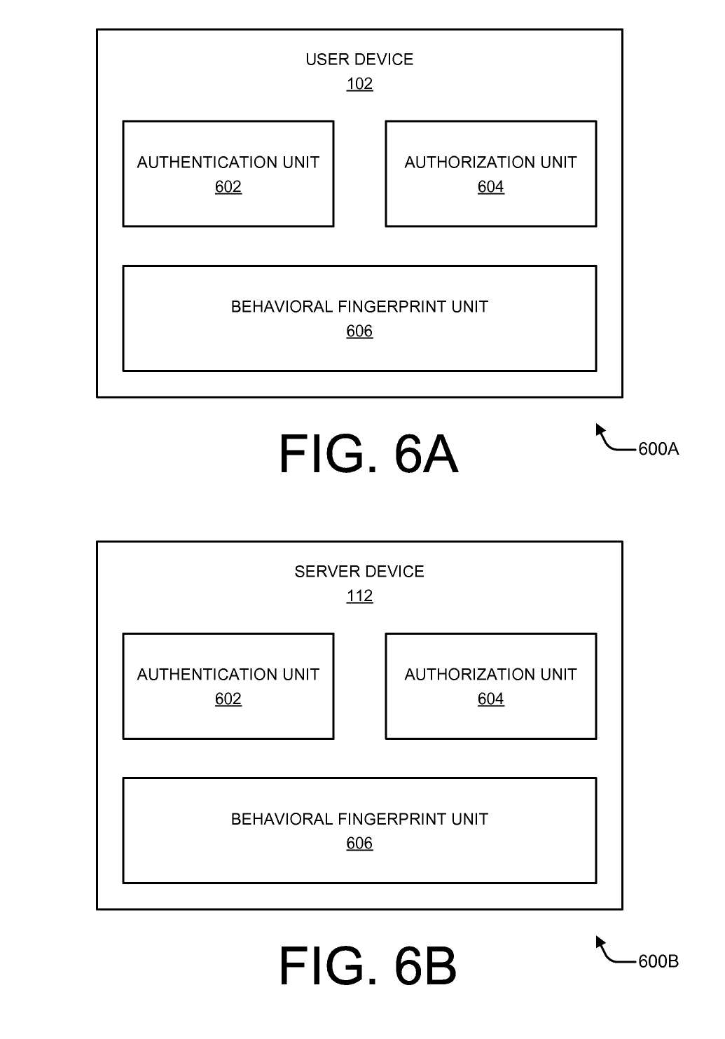

FIGS. 6A and 6B are schematic diagrams 600A and 600B of an example user device and an example server device, respectively, that have one or more functional units in accordance with certain example embodiments. As shown in FIGS. 6A and 6B, by way of example but not limitation, schematic diagrams 600A and 600B may comprise a user device 102 and a server device 112, respectively. As illustrated in schematic diagrams 600A and 600B, a user device 102 or a server device 112 may include, but are not limited to, at least one authentication unit 602, at least one authorization unit 604, at least one behavioral fingerprint unit 606, a combination thereof, or so forth. However, a user device 102 or a server device 112 may alternatively include more, fewer, or different unit(s) from those that are illustrated without departing from claimed subject matter.

For certain example embodiments, a unit may be comprised of at least one processor (e.g., a processor 402 of FIG. 4, a processor 502 of FIG. 5, a combination thereof, etc.), one or more media (e.g., a medium 404 of FIG. 4, a media medium 504 of FIG. 5, a combination thereof, etc.), instructions (e.g., processor-executable instructions, instructions 420 of FIG. 4, instructions 518 of FIG. 5, computer-implementable instructions, a combination thereof, etc.), logic (e.g., logic 406 of FIG. 4, logic 506 of FIG. 5, a combination thereof, etc.), circuitry (e.g., circuitry 408 of FIG. 4, circuitry 508 of FIG. 5, a combination thereof, etc.), other described or illustrated component(s), some combination thereof, or so forth. For certain example implementations, one or more units (e.g., an authentication unit 602, an authorization unit 604, a behavioral fingerprint unit 606, a combination thereof, etc.) of at least one user device 102 may function or interoperate with one or more units of at least one server device 112. However, claimed subject matter is not limited to any particular described embodiments, implementations, examples, etc.

For certain example embodiments, an authentication unit 602 may operate to authenticate a user of a device. For certain example implementations, a user of a device may be authenticated by determining to some (e.g., reasonable, acceptable, measurable, quantifiable, a combination thereof, etc.) degree an identity of a user. By way of example but not limitation, an authentication unit 602 may enable implementation of multiple degrees of authentication, with different degrees of authentication corresponding to different levels of certainty of an identity of a user. Example aspects related to authentication are described further herein (e.g., at least herein above with particular reference to FIG. 1). However, claimed subject matter is not limited to any particular described embodiments, implementations, examples, etc.

For certain example embodiments, an authorization unit 604 may operate to permit or enable full or at least partial access to, use of, implementation of, execution of, a combination thereof, etc. one or more features, applications, accounts, profiles, data, capabilities, a combination thereof, etc. of at least one device, such as a user device 102 or a server device 112. For certain example implementations, authorization may be fully or at least partially granted, denied, withheld, a combination thereof, etc. based at least partially on an authentication determination, a result from an authentication unit 602, some combination thereof, or so forth. By way of example but not limitation, an authorization unit 604 may provide for different levels of authorization, including but not limited to for a given authorized user, that correspond to different degrees of authentication, that correspond to different user identities, some combination thereof, or so forth. Example aspects related to authorization are described further herein (e.g., at least herein above with particular reference to FIG. 1). However, claimed subject matter is not limited to any particular described embodiments, implementations, examples, etc.

For certain example embodiments, a behavioral fingerprint unit 606 may operate to implement, perform, facilitate performance of, a combination thereof, etc. one or more flow diagrams, methods, processes, procedures, operations, functionality, technology, mechanisms, a combination thereof, etc. that are described herein or illustrated in the accompanying drawings or that relate to at least one behavioral fingerprint. For certain example implementations, a behavioral fingerprint unit 606 may provide information, monitored acts, likelihood values, determinations, comparisons, analyses, indications, predicted acts, a combination thereof, etc. to an authentication unit 602 on which it may at least partially base an authentication determination. Example aspects related to behavioral fingerprinting are described further herein above and below. However, claimed subject matter is not limited to any particular described embodiments, implementations, examples, etc.

FIG. 7A is a schematic diagram 700A that includes at least one example device that is capable of handling scenarios for behavioral fingerprinting via corroborative user device in accordance with certain example embodiments. As shown in FIG. 7A, by way of example but not limitation, schematic diagram 700A includes at least one device that may comprise a proximity indicator ascertainment unit 702 or a proximity indicator incorporation unit 704. More specifically, schematic diagram 700A may include a user device 102 or a server device 112. By way of example but not limitation, a proximity indicator ascertainment unit 702 or a proximity indicator incorporation unit 704 may comprise one or more modules, hardware, software, firmware, logic, circuitry, some combination thereof, or so forth. However, claimed subject matter is not limited to any particular described embodiments, implementations, examples, etc.

For certain example embodiments, a proximity indicator ascertainment unit 702 or a proximity indicator incorporation unit 704 may be implemented separately or at least partially jointly or in combination. A proximity indicator ascertainment unit 702 may be configured to ascertain at least one indicator of a proximity of at least one corroborative user device that is affiliated with a behavioral fingerprint. A proximity indicator incorporation unit 704 may be configured to incorporate the at least one indicator of a proximity of the at least one corroborative user device into an authentication-related analysis for a user device that is associated with the behavioral fingerprint. However, claimed subject matter is not limited to any particular described embodiments, implementations, examples, etc.

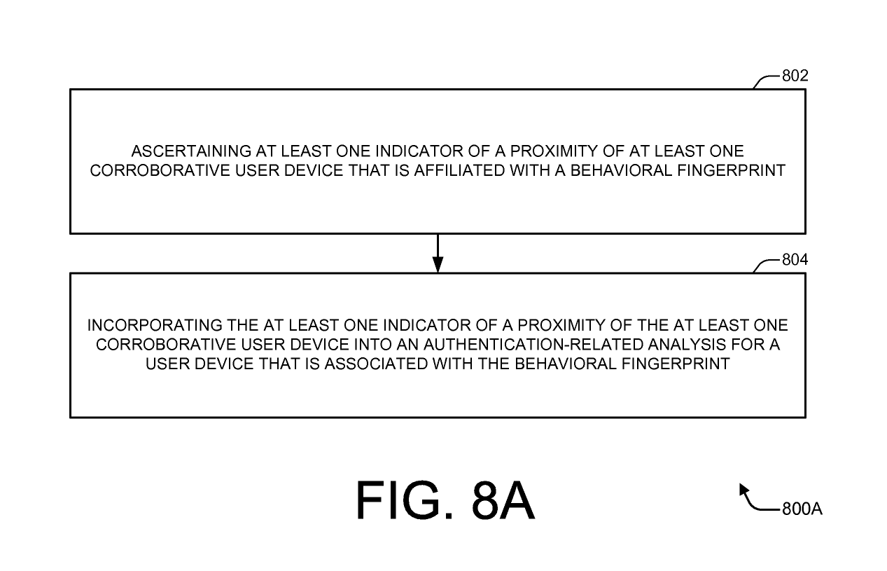

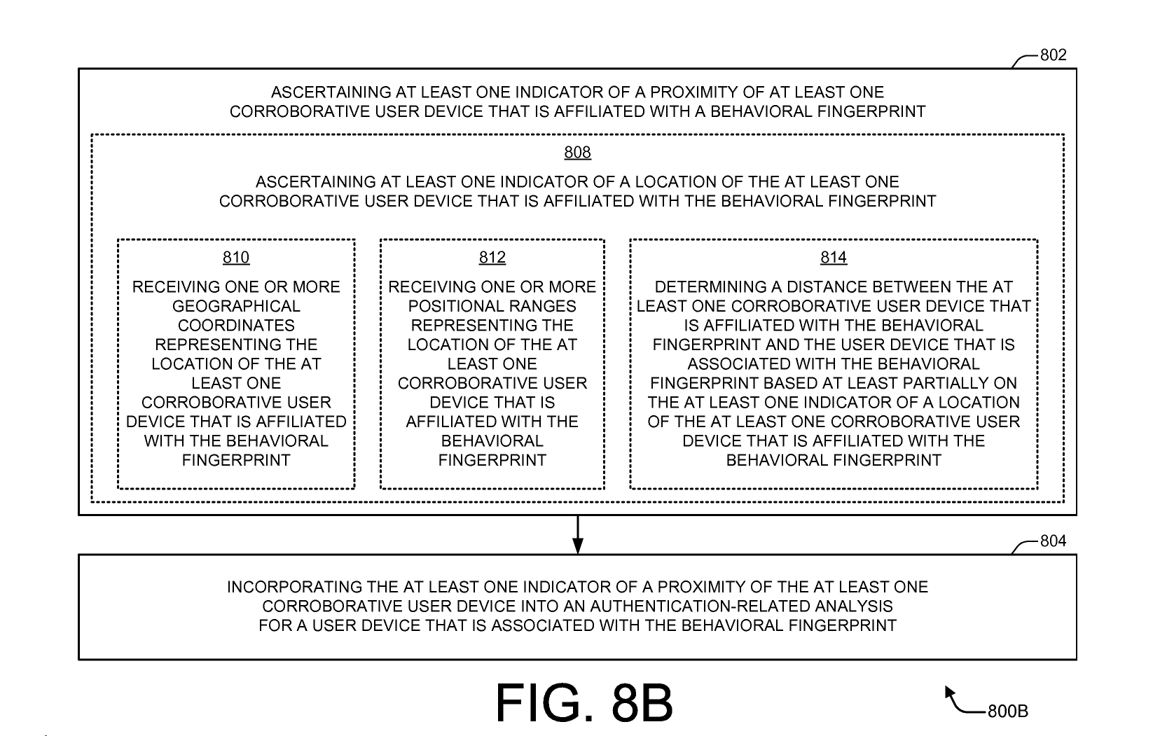

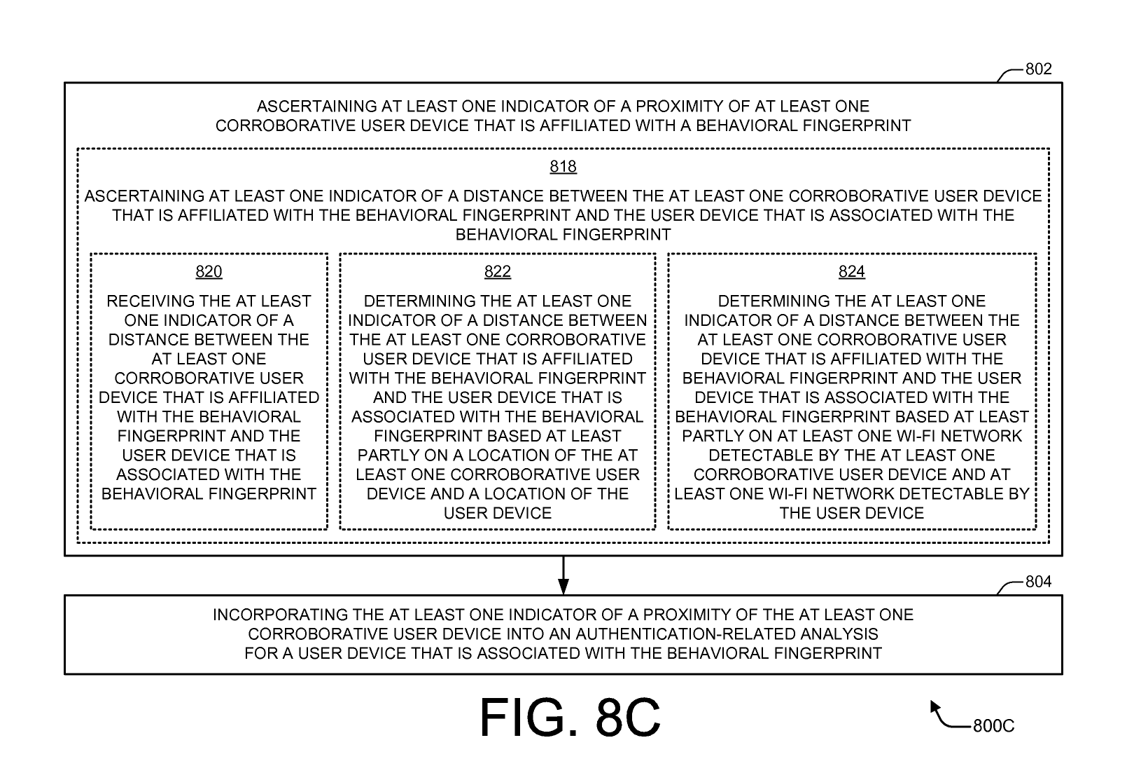

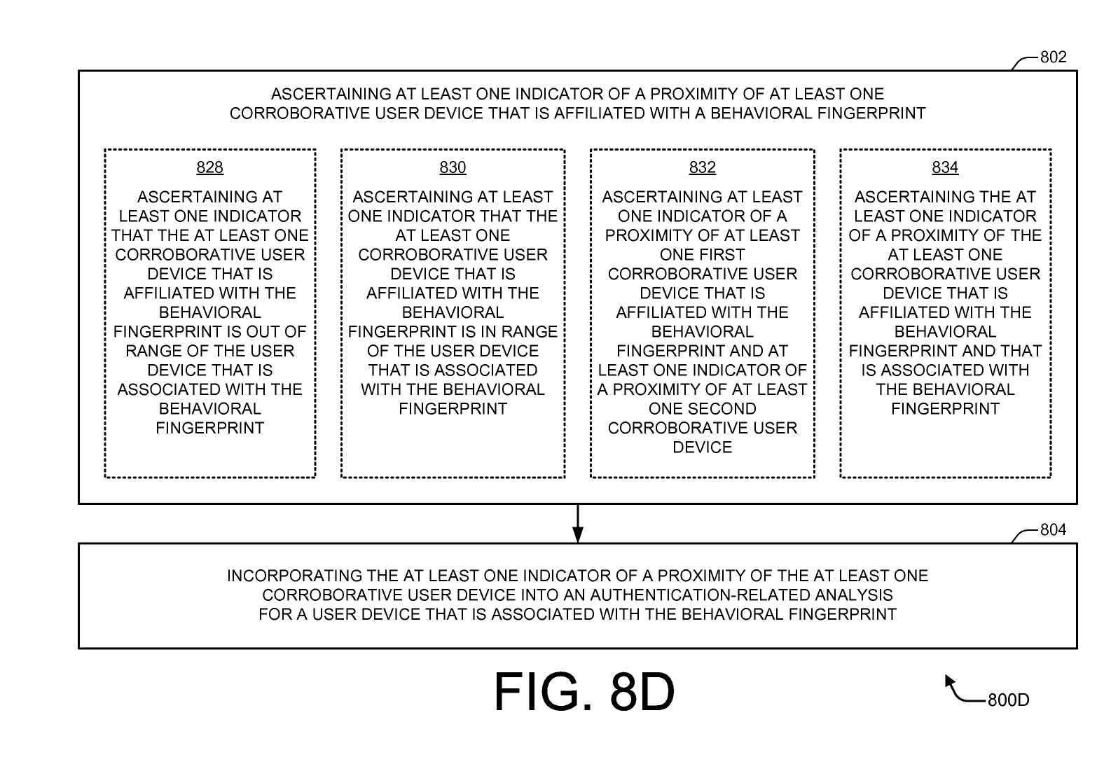

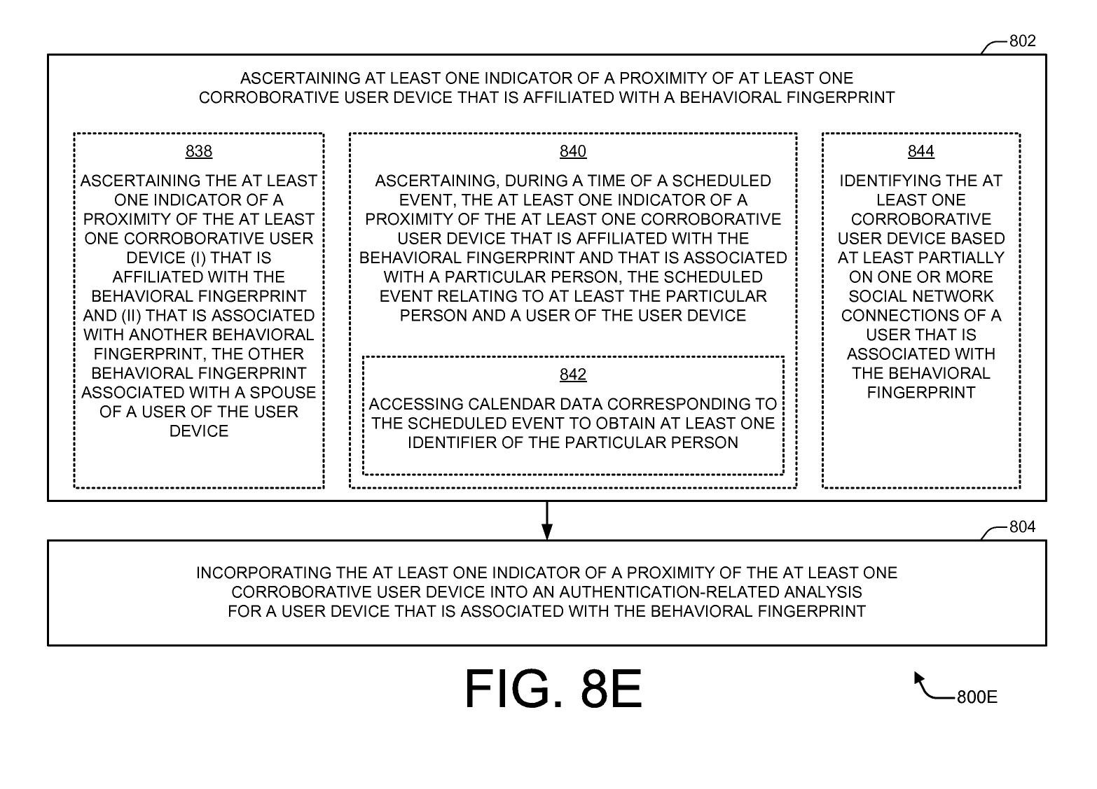

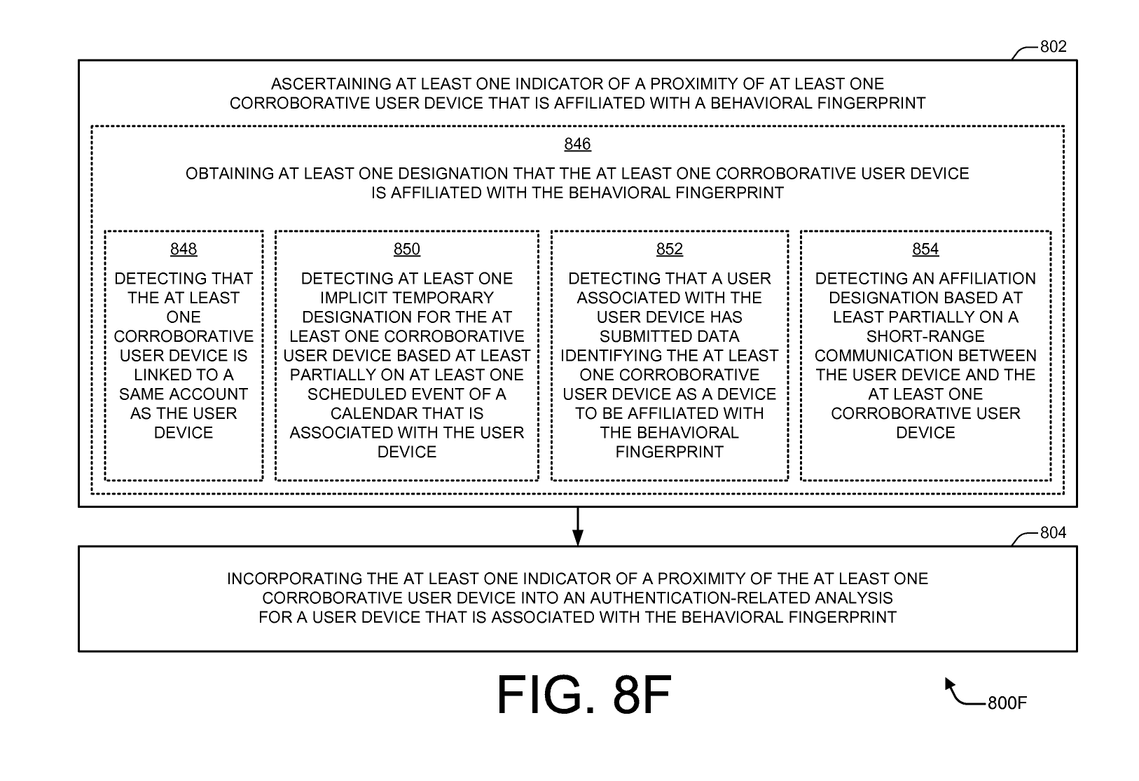

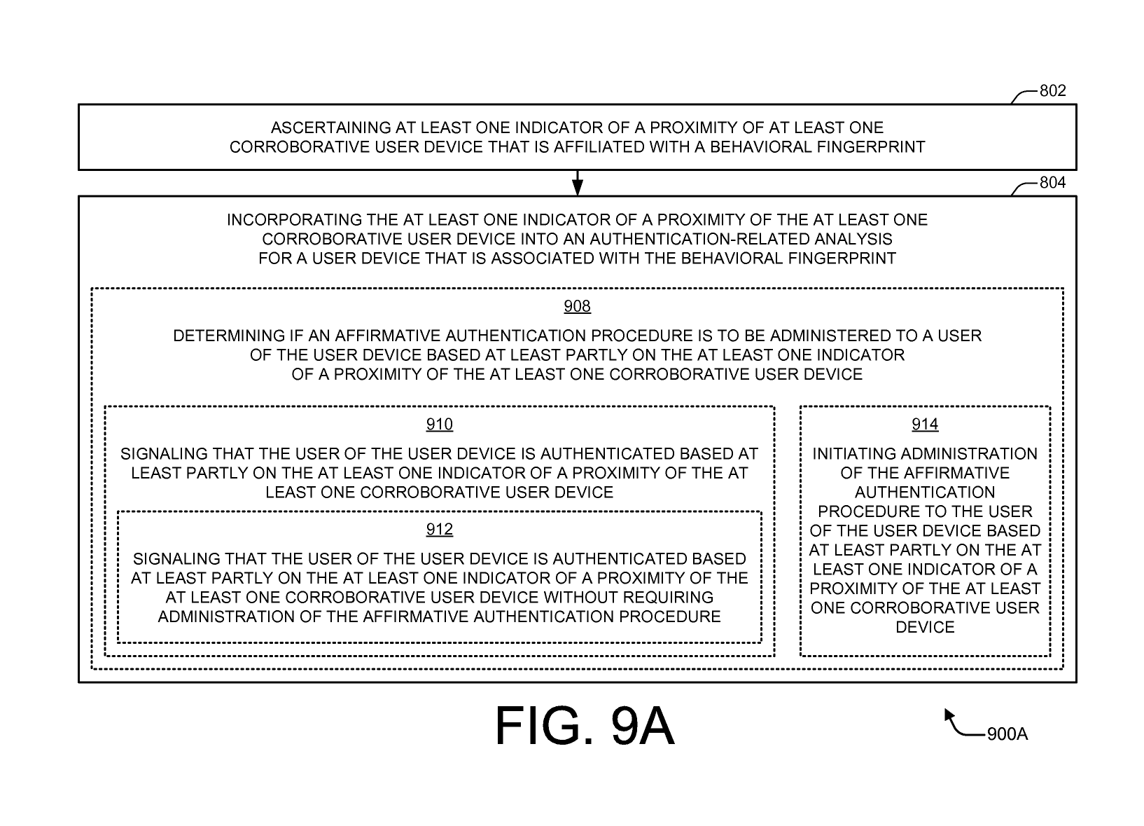

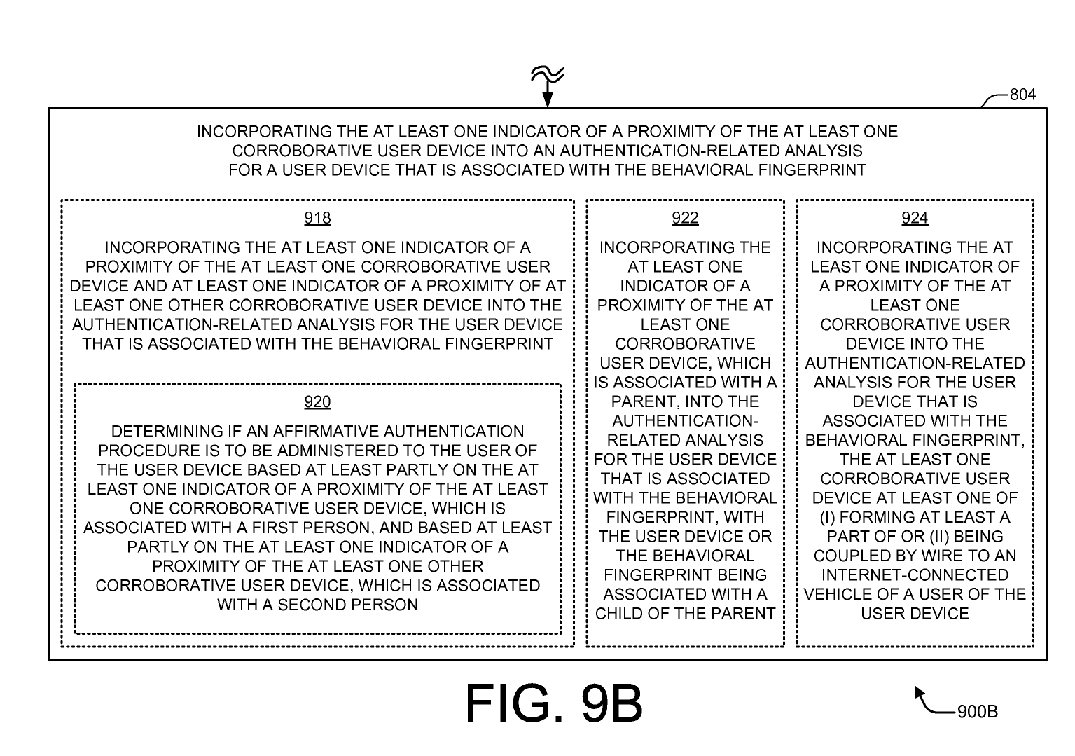

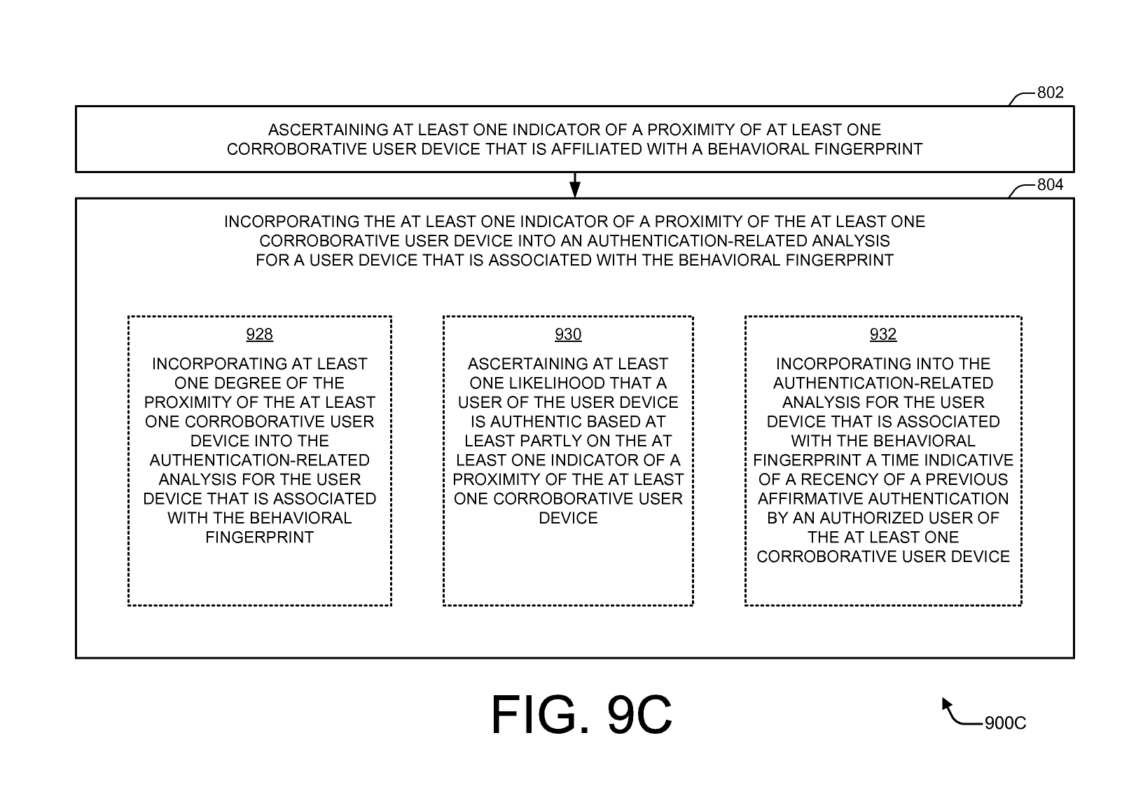

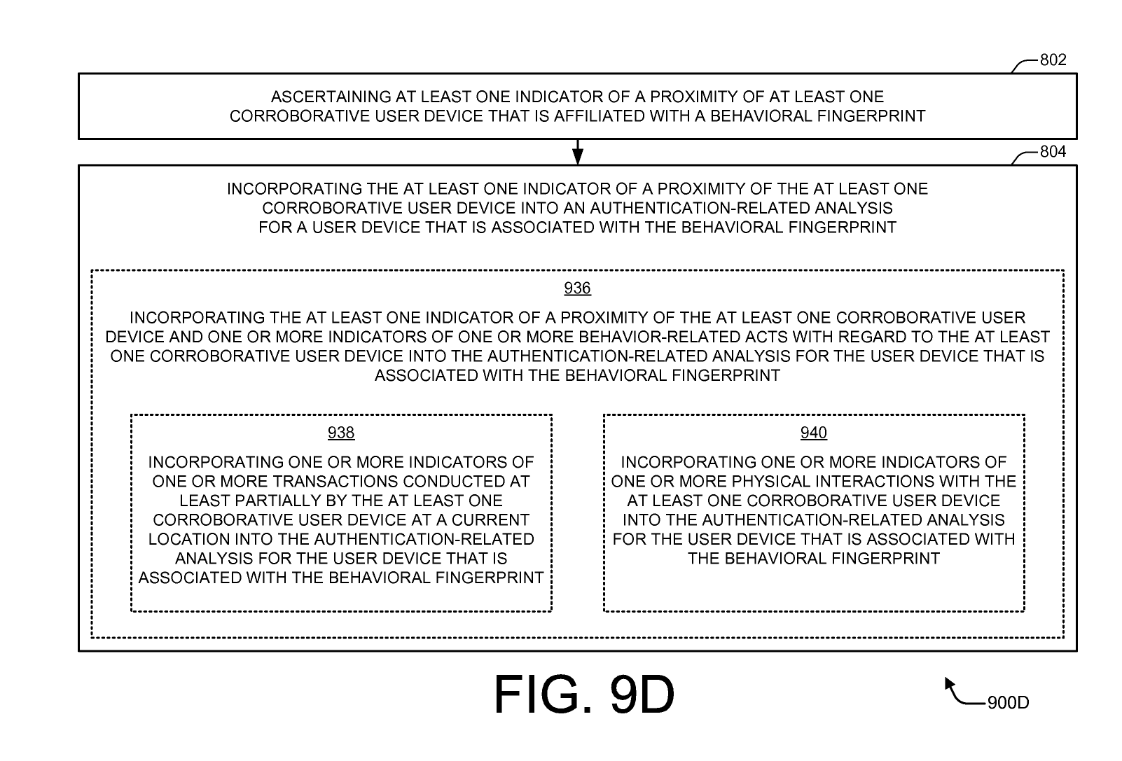

FIGS. 7B-7D are schematic diagrams 700B-700D that include at least one example device and that depict example scenarios for implementing behavioral fingerprinting via corroborative user device in accordance with certain example embodiments. As shown in FIGS. 7B-7D, by way of example but not limitation, one or more of schematic diagrams 700B-700D may include at least one user device 102, at least one corroborative user device 102c, at least one user 104, at least one behavioral fingerprint 110, at least one server device 112, at least one proximity indicator 706, at least one authentication-related analysis 708, or at least one incorporation 710. Each of schematic diagrams 700B-700D may include alternative or additional depictions, which may relate to behavioral fingerprinting via corroborative user device, as described herein. In addition to or in alternative to description herein below with specific reference to FIGS. 7B-7D, illustrated aspects of schematic diagrams 700B-700D may be relevant to example description with reference to FIG. 8A-8F or 9A-9D. However, claimed subject matter is not limited to any particular described embodiments, implementations, examples, etc.

As shown in FIG. 7B, by way of example but not limitation, schematic diagram 700B may include at least one user device 102, at least one corroborative user device 102c, at least one user 104, at least one behavioral fingerprint 110, at least one server device 112, at least one proximity indicator 706, at least one authentication-related analysis 708, or at least one incorporation 710. More specifically, schematic diagram 700B may include: a user device 102 that may correspond to a user 104, which user may comprise an authorized user or an unauthorized user; a corroborative user device 102c, which may correspond to a same or a different user 104; a server device 112, which may operate within a cloud (e.g., as shown in FIG. 7D); a proximity indicator 706; an authentication-related analysis 708, which may relate to at least consideration of performing an authentication operation with respect to user device 102 or user 104; or at least one incorporation 710, which may include application of proximity indicator 706 to authentication-related analysis 708. For certain example embodiments, at least one proximity indicator 706 may include an indication of location of a corroborative user device 102c in absolute terms or relative to a user device 102. For certain example embodiments, an authentication-related analysis 708 may include or relate to a decision, a determination, a process, a combination thereof, etc. of if or whether or when an authentication procedure is to be performed on a user 104 or on behalf of a user device 102 or in accordance with a behavioral fingerprint 110. For certain example implementations, an incorporation 710 may include incorporating (i) at least a portion of a proximity indicator 706 or (ii) a derivation of or value resulting from a proximity indicator 706 into at least one authentication-related analysis 708. However, claimed subject matter is not limited to any particular described embodiments, implementations, examples, etc.

As shown in FIG. 7C, by way of example but not limitation, schematic diagram 700C may include at least one user device 102, at least one corroborative user device 102c, at least one user 104, at least one behavioral fingerprint 110, at least one server device 112, at least one proximity indicator 706, at least one authentication-related analysis 708, at least one incorporation 710, at least one behavioral fingerprint 110c that is associated with corroborative user device 102c, or an other device 712. Additional or alternative description that may be relevant to schematic diagram 700C is provided herein below with particular reference to one or more of any of FIGS. 8A-8F or FIGS. 9A-9D.

For certain example embodiments, an other device 712 may be operated or owned by a user 104 of a user device 102 or a corroborative user device 102c, may be operated or owned by a service provider, may be operated or owned by a social network, may be operated or owned by a third party, may be operated or owned by a proprietor of an establishment, may be operated by one of the above and owned by another, and so forth. For certain example implementations, other device 712 may be communicatively coupled to a user device 102, a corroborative user device 102c, a server device 112, a combination thereof, and so forth. By way of example but not limitation, other device 712: may be integrated with a user device 102 or a corroborative user device 102c (device 102/102c), may be physically connected to a device 102/102c, may be wirelessly coupled to a device 102/102c, may be coupled by wire to a device 102/102c, may be coupled by wire or wirelessly to a server device 112, some combination thereof, and so forth. Other device 712 may additionally or alternatively be capable of bidirectional or unidirectional communication with multiple servers 112 (e.g., of a cloud computing environment or via one or more channels 108 (e.g., of FIGS. 1 and 2A), which channel(s) 108 may include at least part of at least one network, such as an internet). Other device 712 may comprise, by way of example but not limitation, a point-of-sale (POS) terminal, such as a register; an attachment augmenting a POS terminal; an attachment to a device 102/102c; a device that accepts credit, debit, or other payment cards and is coupled to a device 102/102c; a device that accepts or generates sensor readings and forwards them to a server 112; a device that collects, determines, or forwards location data; a device that forwards other data collected or produced at a device 102/102c to a server 112; a combination thereof; or so forth. Data (e.g., relating to behavioral fingerprinting, social networking, location, user-device interactions, a combination thereof, etc.) may be collected at or by other device 712 or funneled through other device 712 between or among at least one user device 102 or corroborative user device 102c or one or more server devices 112. However, claimed subject matter is not limited to any particular described embodiments, implementations, examples, etc. Additional or alternative description that may be relevant to schematic diagram 700C is provided herein below with particular reference to one or more of any of FIGS. 8A-8F or FIGS. 9A-9D.

As shown in FIG. 7D, by way of example but not limitation, schematic diagram 700D may include at least one user device 102, at least one corroborative user device 102c-1 or 102c-2, at least one user 104, at least one behavioral fingerprint 110, at least one server device 112, at least one proximity indicator 706-1 or 706-2, at least one authentication-related analysis 708, at least one incorporation 710, at least one cloud 714, or at least one social network 716. For certain example embodiments, a cloud 714 may comprise at least a portion of a server device, one or more server devices, a provider or utilizer of a cloud service, a provider or utilizer of cloud computing, a combination thereof, or so forth. Additional or alternative description that may be relevant to schematic diagram 700D is provided herein below with particular reference to one or more of any of FIGS. 8A-8F or FIGS. 9A-9D.

For certain example embodiments, a server device 112 may be operated by or for a social network 716 (or other third party service provider). A social network 716 may include, by way of example but not imitation, a network, a service, an internet location, a website, a computing infrastructure, an application, an interface, cloud computing, or a combination thereof, etc. that enables or facilitates interaction (e.g., via text, images, audio, video, or a combination thereof, etc.) between or among two or more members of a social network. The term “social” in “social network” should not be interpreted to exclude networks designed or intended for professional or specific purposes. Examples of social networks may include, but are not limited to, Facebook, Google+, Twitter, Linkedln, Myspace, Pinterest, Classmates[dot]com, Flickr, Foursquare, Friendster, LiveJournal, Meetup, Netlog, Orkut, Sina Weibo, Qzone, Habbo, Instagram, or so forth. Additional or alternative description that may be relevant to schematic diagram 700D is provided herein below with particular reference to one or more of any of FIGS. 8A-8F or FIGS. 9A-9D.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

FIG. 8A is a flow diagram 800A illustrating an example method for at least one device with regard to behavioral fingerprinting via corroborative user device in accordance with certain example embodiments. As illustrated, flow diagram 800A may include any of operations 802-804. Although operations 802-804 are shown or described in a particular order, it should be understood that methods may be performed in alternative manners without departing from claimed subject matter, including, but not limited to, with a different order or number of operations or with a different relationship between or among operations. Also, at least some operation(s) of flow diagram 800A may be performed so as to be fully or partially overlapping with other operation(s). For certain example embodiments, one or more operations of flow diagram 800A may be performed by at least one server device (e.g., a server device 112). Alternatively, one or more operations of flow diagram 800A may be performed by at least one user device (e.g., a user device 102).

For certain example embodiments, a method for behavioral fingerprinting via corroborative user device, which method may be at least partially implemented using hardware (e.g., circuitry, at least one processor, processor-accessible memory, a combination thereof, etc.) such as that of a server device, may comprise an operation 802 or an operation 804. An operation 802 may be directed at least partially to ascertaining at least one indicator of a proximity of at least one corroborative user device that is affiliated with a behavioral fingerprint. For certain example implementations, at least one device (e.g., a server device 112) may ascertain (e.g., obtain, determine, receive, retrieve, calculate, derive, discover, deduce, or a combination thereof, etc.) at least one indicator 706 (e.g., at least one reference, at least one variable, at least one value, at least one pointer, at least one label, at least one categorization, at least one code, or a combination thereof, etc.) of a proximity (e.g., at least one location; at least one distance from, to, or between; at least one range; at least one area; or a combination thereof; etc.) of at least one corroborative (e.g., corroborating, potentially corroborating, supporting, potentially supporting, confirming, potentially confirming, making more certain, potentially making more certain, or a combination thereof, etc.) user device 102c that is affiliated with (e.g., referenced by, linked to, associated with, identified by, or a combination thereof, etc.) a behavioral fingerprint 110. By way of example but not limitation, a server may ascertain at least one indicator of a proximity of at least one corroborative user device that is affiliated with a behavioral fingerprint (e.g., an Apple server may acquire data that directly or indirectly provides a location of a friend's iPhone or a distance between a friend's iPhone and a user's iPhone with the friend's iPhone being identified as an option to support authentication of a user of the user's iPhone by virtue of being linked to a behavioral fingerprint associated with the user or the user's iPhone). However, claimed subject matter is not limited to any particular described embodiments, implementations, examples, etc.

For certain example embodiments, an operation 804 may be directed at least partially to incorporating the at least one indicator of a proximity of the at least one corroborative user device into an authentication-related analysis for a user device that is associated with the behavioral fingerprint. For certain example implementations, at least one device (e.g., a server device 112) may incorporate 710 (e.g., include, add, consider, apply, make use of, factor into, account for, supplement with, a combination thereof, etc.) at least one indicator of a proximity 706 of at least one corroborative user device 102c into an authentication-related analysis 708 (e.g., an analysis to determine if a current user is to be judged authentic, an analysis to determine if an affirmative authentication procedure is to be administered to a current user, an analysis to determine if a current user probably comprises an authorized user, an authorization analysis related to authentication of a user, an analysis producing a likelihood of a current user being authentic or an unauthorized user, or a combination thereof, etc.) for a user device 102 that is associated with (e.g., tied to, capable of being operated in accordance with, interacted with so as to contribute toward behavioral indications for, a combination thereof, etc.) a behavioral fingerprint 110. By way of example but not limitation, a server may incorporate at least one indicator of a proximity of at least one corroborative user device into an authentication-related analysis for a user device that is associated with a behavioral fingerprint (e.g., a Google server may include as an input for a decision, which decision pertains to whether to require a current user of a Motorola Droid phone to enter a passcode for authentication purposes, one or more geographic coordinates of a Samsung Galaxy Tab tablet computer, with the Motorola Droid phone and the Samsung Galaxy Tab tablet computer being registered to a same Google Account). However, claimed subject matter is not limited to any particular described embodiments, implementations, examples, etc.

FIGS. 8B-8F depict example additions or alternatives for a flow diagram of FIG. 8A in accordance with certain example embodiments. As illustrated, flow diagrams of FIGS. 8B-8F may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 8B-8F may be performed so as to be fully or partially overlapping with other operation(s). For certain example embodiments, one or more operations of flow diagrams 800B-800F (of FIGS. 8B-8F) may be performed by at least one server device (e.g., a server device 112). Alternatively, one or more operations of flow diagrams 800B-800F may be performed by at least one user device (e.g., a user device 102).

FIG. 8B illustrates a flow diagram 800B having example operations 808, 810, 812, or 814. For certain example embodiments, an operation 808 may be directed at least partially to wherein the ascertaining at least one indicator of a proximity of at least one corroborative user device that is affiliated with a behavioral fingerprint (of operation 802) comprises ascertaining at least one indicator of a location of the at least one corroborative user device that is affiliated with the behavioral fingerprint. For certain example implementations, at least one device may ascertain at least one indicator of a location (e.g., an “absolute” location such as an address, a business or neighborhood name, one or more satellite positioning system (SPS) coordinates, or a combination thereof, etc.; a “relative” location such as a distance from a cell tower, a Wi-Fi network coverage area, or a combination thereof, etc.; some combination thereof; or so forth) of at least one corroborative user device 102c that is affiliated with a behavioral fingerprint 110. By way of example but not limitation, a server may ascertain at least one indicator of a location of at least one corroborative user device that is affiliated with a behavioral fingerprint (e.g., an Apple iCloud server may determine at least an approximate location of another iOS device, such as an iPad, that is on a same Apple Account as an iPhone from a Wi-Fi network that is detectable by the iPad). However, claimed subject matter is not limited to any particular described embodiments, implementations, examples, etc.

For certain example embodiments, an operation 810 may be directed at least partially to wherein the ascertaining at least one indicator of a location of the at least one corroborative user device that is affiliated with the behavioral fingerprint (of operation 808) comprises receiving one or more geographical coordinates representing the location of the at least one corroborative user device that is affiliated with the behavioral fingerprint. For certain example implementations, at least one device may receive (e.g., from a server 112 that is operated by a same or a different entity from one performing operation 812, from a location service, from a user device 102, from a corroborative user device 102c, from a wireless service provider, from a store, or a combination thereof, etc.) one or more geographical coordinates (e.g., SPS coordinates, global positioning system (GPS) coordinates, map coordinates such as degrees/minutes/minutes or decimal degrees, or a combination thereof, etc.) representing a location of at least one corroborative user device 102c that is affiliated with a behavioral fingerprint 110. By way of example but not limitation, a server may receive one or more geographical coordinates representing a location of at least one corroborative user device that is affiliated with a behavioral fingerprint (e.g., an Apple server may receive GPS coordinates corresponding to an iPad that is linked to a behavioral fingerprint associated with an iPhone). However, claimed subject matter is not limited to any particular described embodiments, implementations, examples, etc.

For certain example embodiments, an operation 812 may be directed at least partially to wherein the ascertaining at least one indicator of a location of the at least one corroborative user device that is affiliated with the behavioral fingerprint (of operation 808) comprises receiving one or more positional ranges representing the location of the at least one corroborative user device that is affiliated with the behavioral fingerprint. For certain example implementations, at least one device may receive (e.g., from a server 112 that is operated by a same or a different entity from one performing operation 812, from a location service, from a user device 102, from a corroborative user device 102c, from a wireless service provider, from a store, or a combination thereof, etc.) one or more positional ranges (e.g., a span of least and greatest likely distances such as 10-30 meters, a distance with a plus/minus error such as 50+/−10 feet, a transmission space around a communication tower such as a circle with a known or determinable radius, an area covered by a beam produced by a beam-forming antenna, an imprecise area such as a block or neighborhood, or a combination thereof, etc.) representing a location of at least one corroborative user device 102c that is affiliated with a behavioral fingerprint 110. By way of example but not limitation, a server may receive one or more positional ranges representing a location of at least one corroborative user device that is affiliated with a behavioral fingerprint (e.g., a Google server may receive an identification of a cell tower in communication with a second phone, or a spatial territory corresponding thereto, with the second phone linked to a first phone that has or is associated with a Google Wallet account). However, claimed subject matter is not limited to any particular described embodiments, implementations, examples, etc.

For certain example embodiments, an operation 814 may be directed at least partially to wherein the ascertaining at least one indicator of a location of the at least one corroborative user device that is affiliated with the behavioral fingerprint (of operation 808) comprises determining a distance between the at least one corroborative user device that is affiliated with the behavioral fingerprint and the user device that is associated with the behavioral fingerprint based at least partially on the at least one indicator of a location of the at least one corroborative user device that is affiliated with the behavioral fingerprint. For certain example implementations, at least one device may determine (e.g., divine, calculate, estimate, ascertain, approximate, or a combination thereof, etc.) a distance (e.g., a length in feet, a span in meters, a length with an error range, an estimate between two approximate locations, or a combination thereof, etc.) between at least one corroborative user device 102c that is affiliated with a behavioral fingerprint 110 and a user device 102 that is associated with behavioral fingerprint 110 based at least partially on at least one indicator of a location of at least one corroborative user device 102c that is affiliated with behavioral fingerprint 110. By way of example but not limitation, a server may determine a distance between at least one corroborative user device that is affiliated with a behavioral fingerprint and a user device that is associated with the behavioral fingerprint based at least partially on at least one indicator of a location of the at least one corroborative user device that is affiliated with the behavioral fingerprint (e.g., a Walmart server may determine that less than 100 meters separates a husband's smartphone from a wife's smartphone when the wife is attempting to pay for products with her smartphone in a checkout lane in a store based at least partly on GPS coordinates corresponding to the husband's smartphone, and GPS coordinates corresponding to the wife's smartphone or a determinable location of the checkout lane). However, claimed subject matter is not limited to any particular described embodiments, implementations, examples, etc.

FIG. 8C illustrates a flow diagram 800C having example operations 818, 820, 822, or 824. For certain example embodiments, an operation 818 may be directed at least partially to wherein the ascertaining at least one indicator of a proximity of at least one corroborative user device that is affiliated with a behavioral fingerprint (of operation 802) comprises ascertaining at least one indicator of a distance between the at least one corroborative user device that is affiliated with the behavioral fingerprint and the user device that is associated with the behavioral fingerprint. For certain example implementations, at least one device may ascertain at least one indicator of a distance (e.g., a length in feet, a span in meters, a length with an error range, an estimate between two approximate locations, a label connoting relative closeness such as “same room” or “same block”, or a combination thereof, etc.) between at least one corroborative user device 102c that is affiliated with a behavioral fingerprint 110 and a user device 102 that is associated with behavioral fingerprint 110. By way of example but not limitation, a server may ascertain at least one indicator of a distance between at least one corroborative user device that is affiliated with a behavioral fingerprint and a user device that is associated with a behavioral fingerprint (e.g., a Google server may calculate that 10-30 meters separates a child's Apple iPhone that is to be used to purchase a pair of jeans and a parent's Microsoft Windows Phone 8 smartphone). However, claimed subject matter is not limited to any particular described embodiments, implementations, examples, etc.

For certain example embodiments, an operation 820 may be directed at least partially to wherein the ascertaining at least one indicator of a distance between the at least one corroborative user device that is affiliated with the behavioral fingerprint and the user device that is associated with the behavioral fingerprint (of operation 818) comprises receiving the at least one indicator of a distance between the at least one corroborative user device that is affiliated with the behavioral fingerprint and the user device that is associated with the behavioral fingerprint. For certain example implementations, at least one device may receive (e.g., from a server 112 that is operated by a same or a different entity, from a location service, from a user device 102, from a corroborative user device 102c, from a wireless service provider, from a store, or a combination thereof, etc.) at least one indicator of a distance between at least one corroborative user device 102c that is affiliated with a behavioral fingerprint 110 and a user device that is associated with behavioral fingerprint 110. By way of example but not limitation, a server may receive at least one indicator of a distance between at least one corroborative user device that is affiliated with a behavioral fingerprint and a user device that is associated with the behavioral fingerprint (e.g., a PayPal server may receive a “neighborhood” proximity label that indicates that a parent's internet-connected vehicle is within several hundred feet of a child's iPhone that is to be used to purchase frozen yogurt). However, claimed subject matter is not limited to any particular described embodiments, implementations, examples, etc.

For certain example embodiments, an operation 822 may be directed at least partially to wherein the ascertaining at least one indicator of a distance between the at least one corroborative user device that is affiliated with the behavioral fingerprint and the user device that is associated with the behavioral fingerprint (of operation 818) comprises determining the at least one indicator of a distance between the at least one corroborative user device that is affiliated with the behavioral fingerprint and the user device that is associated with the behavioral fingerprint based at least partly on a location of the at least one corroborative user device and a location of the user device. For certain example implementations, at least one device may determine (e.g., calculate, estimate, approximate, divine, or a combination thereof, etc.) at least one indicator of a distance between at least one corroborative user device 102c that is affiliated with a behavioral fingerprint 110 and a user device 102 that is associated with behavioral fingerprint 110 based at least partly on a location (e.g., GPS coordinates, a neighborhood label, a street address, or a combination thereof, etc.) of at least one corroborative user device 102c and a location (e.g., GPS coordinates, a neighborhood label, a street address, or a combination thereof, etc.) of user device 102. By way of example but not limitation, a server may determine at least one indicator of a distance between at least one corroborative user device that is affiliated with a behavioral fingerprint and a user device that is associated with the behavioral fingerprint based at least partly on a location of the at least one corroborative user device and a location of the user device (e.g., an Apple server supporting Apple's Passbook service may estimate from first and second GPS coordinates and/or inertial measurement unit (IMU) data for first and second iPhones, respectively, that the two iPhones are co-located within a same store or are approximately 20-50 feet apart). However, claimed subject matter is not limited to any particular described embodiments, implementations, examples, etc.

For certain example embodiments, an operation 824 may be directed at least partially to wherein the ascertaining at least one indicator of a distance between the at least one corroborative user device that is affiliated with the behavioral fingerprint and the user device that is associated with the behavioral fingerprint (of operation 818) comprises determining the at least one indicator of a distance between the at least one corroborative user device that is affiliated with the behavioral fingerprint and the user device that is associated with the behavioral fingerprint based at least partly on at least one Wi-Fi network detectable by the at least one corroborative user device and at least one Wi-Fi network detectable by the user device. For certain example implementations, at least one device may determine (e.g., calculate, estimate, approximate, divine, or a combination thereof, etc.) at least one indicator of a distance between at least one corroborative user device 102c that is affiliated with a behavioral fingerprint 110 and a user device 102 that is associated with behavioral fingerprint 110 based at least partly on at least one Wi-Fi network detectable by at least one corroborative user device 102c and at least one Wi-Fi network detectable by user device 102. By way of example but not limitation, a server may determine at least one indicator of a distance between at least one corroborative user device that is affiliated with a behavioral fingerprint and a user device that is associated with the behavioral fingerprint based at least partly on at least one Wi-Fi network detectable by the at least one corroborative user device and at least one Wi-Fi network detectable by the user device (e.g., a Visa security server may determine that two linked smartphones are capable of detecting a signal from a same Wi-Fi network or are capable of detecting two different signals from two different Wi-Fi networks that are determinable to be geographically close to each other). However, claimed subject matter is not limited to any particular described embodiments, implementations, examples, etc.

FIG. 8D illustrates a flow diagram 800D having example operations 828, 830, 832, or 834. For certain example embodiments, an operation 828 may be directed at least partially to wherein the ascertaining at least one indicator of a proximity of at least one corroborative user device that is affiliated with a behavioral fingerprint (of operation 802) comprises ascertaining at least one indicator that the at least one corroborative user device that is affiliated with the behavioral fingerprint is out of range of the user device that is associated with the behavioral fingerprint. For certain example implementations, at least one device may ascertain at least one indicator that at least one corroborative user device 102c that is affiliated with a behavioral fingerprint 110 is out of range (e.g., not sufficiently close to qualify as corroborating, not sufficiently close to qualify as corroborating given a particular security risk of a requested act such as a download or a purchase, not within a predetermined separation distance, not within a user-specified separation distance, not within a proprietor's or payment-system's specified separation distance, or a combination thereof, etc.) of a user device 102 that is associated with behavioral fingerprint 110. By way of example but not limitation, a server may ascertain at least one indicator that at least one corroborative user device that is affiliated with a behavioral fingerprint is out of range of a user device that is associated with a behavioral fingerprint (e.g., a server operated for or by McAfee may receive a negative signal indicating that a potential corroborating user device, such as a tablet computer, is not sufficiently geographically close to a smartphone attempting to initiate a transaction to support authentication for a current user of the smartphone). However, claimed subject matter is not limited to any particular described embodiments, implementations, examples, etc.

For certain example embodiments, an operation 830 may be directed at least partially to wherein the ascertaining at least one indicator of a proximity of at least one corroborative user device that is affiliated with a behavioral fingerprint (of operation 802) comprises ascertaining at least one indicator that the at least one corroborative user device that is affiliated with the behavioral fingerprint is in range of the user device that is associated with the behavioral fingerprint. For certain example implementations, at least one device may ascertain at least one indicator that at least one corroborative user device 102c that is affiliated with a behavioral fingerprint 110 is in range (e.g., is sufficiently close to qualify as corroborating, is sufficiently close to qualify as corroborating given a particular security risk of a requested act such as writing an email or making a purchase, is within a predetermined separation distance, is within a user-specified separation distance, is within a proprietor's or payment-system's specified separation distance, or a combination thereof, etc.) of a user device 102 that is associated with behavioral fingerprint 110. By way of example but not limitation, a server may ascertain at least one indicator that at least one corroborative user device that is affiliated with a behavioral fingerprint is in range of a user device that is associated with the behavioral fingerprint (e.g., a Nokia server may determine that a potentially corroborating user device, such as one or more smart phones of multiple identified smart phones, is sufficiently geographically close to a smart phone attempting to initiate a transaction to support authentication for a current user of the smart phone that is attempting to initiate a transaction). However, claimed subject matter is not limited to any particular described embodiments, implementations, examples, etc.

For certain example embodiments, an operation 832 may be directed at least partially to wherein the ascertaining at least one indicator of a proximity of at least one corroborative user device that is affiliated with a behavioral fingerprint (of operation 802) comprises ascertaining at least one indicator of a proximity of at least one first corroborative user device that is affiliated with the behavioral fingerprint and at least one indicator of a proximity of at least one second corroborative user device. For certain example implementations, at least one device may ascertain at least one indicator of a proximity 706-1 of at least one first corroborative user device 102c-1 that is affiliated with a behavioral fingerprint 110 and at least one indicator of a proximity 706-2 of at least one second corroborative user device 102c-2. By way of example but not limitation, a server may ascertain at least one indicator of a proximity of at least one first corroborative user device that is affiliated with a behavioral fingerprint and at least one indicator of a proximity of at least one second corroborative user device, which may also be affiliated with the behavioral fingerprint (e.g., a Paypal server may acquire GPS coordinates for an internet-connected vehicle and a “same building” proximity label for a portable entertainment device of a family member of a user of a smartphone that is in the process of being used to purchase a refrigerator, with the internet-connected vehicle and the portable entertainment device identified in a behavioral fingerprint associated with the user or the smartphone as comprising two of multiple potentially corroborating devices). However, claimed subject matter is not limited to any particular described embodiments, implementations, examples, etc.

For certain example embodiments, an operation 834 may be directed at least partially to wherein the ascertaining at least one indicator of a proximity of at least one corroborative user device that is affiliated with a behavioral fingerprint (of operation 802) comprises ascertaining the at least one indicator of a proximity of the at least one corroborative user device that is affiliated with the behavioral fingerprint and that is associated with the behavioral fingerprint. For certain example implementations, at least one device may ascertain at least one indicator 706 of a proximity of at least one corroborative user device 102c that is affiliated with (e.g., that is designated as a corroborative user device for one or more other user devices that are associated with) a behavioral fingerprint 110 and that is associated with (e.g., that is capable of contributing user behaviors as indicators for or being governed by) behavioral fingerprint 110. By way of example but not limitation, a server may ascertain at least one indicator of a proximity of at least one corroborative user device that is affiliated with a behavioral fingerprint and that is associated with the behavioral fingerprint (e.g., a Verizon server may obtain an approximate location of a 4G-broadband-connected Android tablet computer from a cellular network signal/connection to support user authentication for a current user operating a Verizon-network-connected Android smartphone, with usage of both the Android smartphone and the Android tablet computer being observed over time to generate or update a behavioral fingerprint for an authorized user of both devices). However, claimed subject matter is not limited to any particular described embodiments, implementations, examples, etc.

FIG. 8E illustrates a flow diagram 800E having example operations 838, 840, 842, or 844. For certain example embodiments, an operation 838 may be directed at least partially to wherein the ascertaining at least one indicator of a proximity of at least one corroborative user device that is affiliated with a behavioral fingerprint (of operation 802) comprises ascertaining the at least one indicator of a proximity of the at least one corroborative user device (i) that is affiliated with the behavioral fingerprint and (ii) that is associated with another behavioral fingerprint, the other behavioral fingerprint associated with a spouse of a user of the user device. For certain example implementations, at least one device may ascertain at least one indicator of a proximity 706 of at least one corroborative user device 102c (i) that is affiliated with (e.g., that is designated as a corroborative user device for one or more user devices that are associated with) a behavioral fingerprint 110 and (ii) that is associated with (e.g., that (i) is capable of contributing user interactions or other behaviors to establish or modify or (ii) is capable of being affected by) another behavioral fingerprint 110c, with the other behavioral fingerprint 110c associated with a spouse of a user 104 of a user device 102. By way of example but not limitation, a server may ascertain at least one indicator of a proximity of at least one corroborative user device (i) that is affiliated with a behavioral fingerprint and (ii) that is associated with another behavioral fingerprint, with the other behavioral fingerprint associated with a spouse of a user of a user device (e.g., in response to an expressed intention to purchase a big screen television at Best Buy with a first smartphone of a first spouse, a Kaspersky server may divine a location of a second smartphone of a second spouse that is associated with a second behavioral fingerprint for the second spouse, with the first smartphone being associated with a first behavioral fingerprint for the first spouse). However, claimed subject matter is not limited to any particular described embodiments, implementations, examples, etc.

For certain example embodiments, an operation 840 may be directed at least partially to wherein the ascertaining at least one indicator of a proximity of at least one corroborative user device that is affiliated with a behavioral fingerprint (of operation 802) comprises ascertaining, during a time of a scheduled event, the at least one indicator of a proximity of the at least one corroborative user device that is affiliated with the behavioral fingerprint and that is associated with a particular person, the scheduled event relating to at least the particular person and a user of the user device. For certain example implementations, at least one device may ascertain, during a time (e.g., while a an event is scheduled to be occurring, starting at least by when a reminder for a scheduled event is alerting, extending for a reasonable period before or after a scheduled event such as 10-15 minutes for a one-hour meeting or one hour for an eight hour meeting, or a combination thereof, etc.) of a scheduled event (e.g., a meeting, a task, a happening, or a combination thereof, etc. that is noted, memorialized, stored, entered, recorded, or a combination thereof, etc. in an electronic calendar or planner or event organizer), at least one indicator of a proximity 706 of at least one corroborative user device 102c that is affiliated with a behavioral fingerprint 110 and that is associated with a particular person (e.g., an individual, a robotic entity, a human, or a combination thereof, etc.), with the scheduled event relating to (e.g., including, identifying, listing, indicating as attendees, or a combination thereof, etc.) at least the particular person and a user of a user device. By way of example but not limitation, a server may ascertain, during a time of a scheduled event, at least one indicator of a proximity of at least one corroborative user device that is affiliated with a behavioral fingerprint and that is associated with a particular person, with the scheduled event relating to at least the particular person and a user of a user device (e.g., an American Express server may determine a distance between a card member's smartphone and a dining companion's smartphone if the dining companion is included as part of a scheduled meeting of the card member, which scheduled meeting may result in the dining companion's smartphone being implicitly designated as an affiliated corroborative user device with respect to the user device at least around a time of the scheduled meeting). However, claimed subject matter is not limited to any particular described embodiments, implementations, examples, etc.

For certain example embodiments, an operation 842 may be directed at least partially to wherein the ascertaining, during a time of a scheduled event, the at least one indicator of a proximity of the at least one corroborative user device that is affiliated with the behavioral fingerprint and that is associated with a particular person, the scheduled event relating to at least the particular person and a user of the user device (of operation 840) comprises accessing calendar data corresponding to the scheduled event to obtain at least one identifier of the particular person. For certain example implementations, at least one device may access (e.g., read, retrieve, receive, parse, decrypt, or a combination thereof, etc.) calendar data (e.g., an entry included in a calendar program, an entry displayable as part of a calendar program or web page or app, a list of one or more attendees, an indication of a start time, an indication of an ending time, an indication of a reminder time, or a combination thereof, etc.) corresponding to (e.g., describing, representing, pertaining to, or a combination thereof, etc.) a scheduled event to obtain at least one identifier (e.g., a name, a phone number, an email address, an account name, an account number, a username, a handle, or a combination thereof, etc.) of a particular person. By way of example but not limitation, a server may access calendar data corresponding to a scheduled event to obtain at least one identifier of a particular person (e.g., a Google server may inspect a meeting schedule entry from or for a Google Calendar application and retrieve an attendee's name, email address, or phone number). However, claimed subject matter is not limited to any particular described embodiments, implementations, examples, etc.

For certain example embodiments, an operation 844 may be directed at least partially to wherein the ascertaining at least one indicator of a proximity of at least one corroborative user device that is affiliated with a behavioral fingerprint (of operation 802) comprises identifying the at least one corroborative user device based at least partially on one or more social network connections of a user that is associated with the behavioral fingerprint. For certain example implementations, at least one device may identify (e.g., recognize, obtain data uniquely corresponding to, acquire a name of a person who owns or is an authorized user of, obtain a username or account number of, or a combination thereof, etc.) at least one corroborative user device 102c based at least partially on one or more social network 716 connections (e.g., members, friends, followers, group or circle participants, or a combination thereof, etc.) of a user 104 that is associated with a behavioral fingerprint 110. By way of example but not limitation, a server may identify at least one corroborative user device based at least partially on one or more social network connections of a user that is associated with a behavioral fingerprint (e.g., a server, which is capable of providing authentication services, may select or determine at least one corroborating or potentially corroborating smartphone based at least partly on phone numbers corresponding to one or more Facebook friends of a user of an iPhone with the user or the iPhone being associated with a behavioral fingerprint). However, claimed subject matter is not limited to any particular described embodiments, implementations, examples, etc.

FIG. 8F illustrates a flow diagram 800F having example operations 846, 848, 850, 852, or 854. For certain example embodiments, an operation 846 may be directed at least partially to wherein the ascertaining at least one indicator of a proximity of at least one corroborative user device that is affiliated with a behavioral fingerprint (of operation 802) comprises obtaining at least one designation that the at least one corroborative user device is affiliated with the behavioral fingerprint. For certain example implementations, at least one device may obtain (e.g., acquire, determine, detect, receive, or a combination thereof, etc.) at least one designation (e.g., an explicit designation, an implicit designation, an actual designation, a constructive designation, an assertion, an indication, a selection, a pointing out, a specification, a denotation, a tagging, or a combination thereof, etc.) that at least one corroborative user device 102c is affiliated with behavioral fingerprint 110. By way of example but not limitation, a server may obtain at least one designation that at least one corroborative user device is affiliated with a behavioral fingerprint (e.g., a Verizon server may determine that a Motorola Droid smartphone was purchased with a same credit card as is used to pay for monthly wireless broadband communication services for a Motorola tablet computer and designate the Motorola Droid smartphone a corroborative user device with respect to the Motorola tablet computer). However, claimed subject matter is not limited to any particular described embodiments, implementations, examples, etc.

For certain example embodiments, an operation 848 may be directed at least partially to wherein the obtaining at least one designation that the at least one corroborative user device is affiliated with the behavioral fingerprint (of operation 846) comprises detecting that the at least one corroborative user device is linked to a same account as the user device. For certain example implementations, at least one device may detect (e.g., realize, discover, discern, recognize, find out, ascertain, or a combination thereof, etc.) that at least one corroborative user device 102c is linked to a same account (e.g., an identifying name, an identifying number, an address, a username, a phone number, an email address, a handle, an email account, a social network account, a credit card account, a telecommunications service account, a vendor account, an account that enables content sharing, or a combination thereof, etc.) as a user device 102. By way of example but not limitation, a server may detect that at least one corroborative user device is linked to a same account as a user device (e.g., an Apple server may detect that an iPad is on a same Apple account as an iPhone and designate the iPad a corroborative user device with respect to the iPhone, or an Amazon server may detect that a smartphone is linked to a same Amazon account as a Kindle Fire and designate the smartphone a corroborative user device with respect to the Kindle Fire). However, claimed subject matter is not limited to any particular described embodiments, implementations, examples, etc.

For certain example embodiments, an operation 850 may be directed at least partially to wherein the obtaining at least one designation that the at least one corroborative user device is affiliated with the behavioral fingerprint (of operation 846) comprises detecting at least one implicit temporary designation for the at least one corroborative user device based at least partially on at least one scheduled event of a calendar that is associated with the user device. For certain example implementations, at least one device may detect (e.g., realize, discover, discern, recognize, find out, ascertain, or a combination thereof, etc.) at least one implicit temporary designation (e.g., an indirect or non-explicit designation of a finite, non-indefinite length) for at least one corroborative user device 102c based at least partially on at least one scheduled event (e.g., a meeting, a task, a happening, or a combination thereof, etc. that is noted, memorialized, stored, entered, recorded, or a combination thereof, etc. in an electronic calendar or planner or schedule organizer) of a calendar (e.g., an organization of days, hours, dates, or a combination thereof, etc. associated with or linking to one or more scheduled events) that is associated with a user device 102. By way of example but not limitation, a server may detect at least one implicit temporary designation for at least one corroborative user device based at least partially on at least one scheduled event of a calendar that is associated with a user device (e.g., an Exchange ActiveSync server may detect that a particular person, having a particular mobile number for a potentially corroborating user device in accordance with determinable contact information, is scheduled to meet with a user of a user device at a coffee house having a location on 5^{th} and Main Street based at least partly on a meeting entry in an electronic calendar for the user of the user device and may designate the device corresponding to the mobile number a corroborative user device with respect to the user device for around the time of the coffee house meeting). However, claimed subject matter is not limited to any particular described embodiments, implementations, examples, etc.

For certain example embodiments, an operation 852 may be directed at least partially to wherein the obtaining at least one designation that the at least one corroborative user device is affiliated with the behavioral fingerprint (of operation 846) comprises detecting that a user associated with the user device has submitted data identifying the at least one corroborative user device as a device to be affiliated with the behavioral fingerprint. For certain example implementations, at least one device may detect (e.g., realize, discover, discern, recognize, find out, ascertain, or a combination thereof, etc.) that a user 104 associated with a user device 102 has submitted data (e.g., a phone number, a vendor account name, a vendor account number, an instant message identification, an email address, a medium access control (MAC) number or address, an internet protocol (IP) address, an electronic serial number (ESN), a mobile equipment identifier (MEID), a username, a device description, or a combination thereof, etc.) identifying at least one corroborative user device 102c as a device to be affiliated with a behavioral fingerprint 110. By way of example but not limitation, a server may detect that a user associated with a user device has submitted data identifying at least one corroborative user device as a device to be affiliated with a behavioral fingerprint (e.g., a McAfee server may receive from a user a MAC address of a Windows 8 tablet computer via a web interface or an app interface indicating that the Windows 8 tablet computer is to be used for corroborating the user's authentic presence in relation to one or more other user devices). However, claimed subject matter is not limited to any particular described embodiments, implementations, examples, etc.

For certain example embodiments, an operation 854 may be directed at least partially to wherein the obtaining at least one designation that the at least one corroborative user device is affiliated with the behavioral fingerprint (of operation 846) comprises detecting an affiliation designation based at least partially on a short-range communication between the user device and the at least one corroborative user device. For certain example implementations, at least one device may detect (e.g., realize, discover, discern, recognize, find out, ascertain, or a combination thereof, etc.) an affiliation designation (e.g., an indication that another user device may be considered for authentication support purposes) based at least partially on a short-range communication (e.g., infrared communication, Bluetooth communication, near field communication (NFC), direct Wi-Fi communication between two devices such as when one device functions as a Wi-Fi hotspot for the other, or a combination thereof, etc.) between a user device 102 and at least one corroborative user device 102c. By way of example but not limitation, a server may detect an affiliation designation based at least partially on a short-range communication between a user device and at least one corroborative user device (e.g., a Google server may receive an indication that a user's Android smartphone has been tapped to another person's smartphone as part of a near field communication (NFC) electronic contact or exchange, so the Google server may mark the other person's smartphone as being designated as an affiliated corroborative user device with respect to the user's Android smartphone). However, claimed subject matter is not limited to any particular described embodiments, implementations, examples, etc.

FIGS. 9A-9D depict example additions or alternatives for a flow diagram of FIG. 8A in accordance with certain example embodiments. As illustrated, flow diagrams of FIGS. 9A-9D may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently). Also, at least some operation(s) of flow diagrams of FIGS. 9A-9D may be performed so as to be fully or partially overlapping with other operation(s). For certain example embodiments, one or more operations of flow diagrams 900A-900D (of FIGS. 9A-9D) may be performed by at least one server device (e.g., a server device 112). Alternatively, one or more operations of flow diagrams 900A-900D may be performed by at least one user device (e.g., a user device 102).

FIG. 9A illustrates a flow diagram 900A having example operations 908, 910, 912, or 914. For certain example embodiments, an operation 908 may be directed at least partially to wherein the incorporating the at least one indicator of a proximity of the at least one corroborative user device into an authentication-related analysis for a user device that is associated with the behavioral fingerprint (of operation 804) comprises determining if an affirmative authentication procedure is to be administered to a user of the user device based at least partly on the at least one indicator of a proximity of the at least one corroborative user device. For certain example implementations, at least one device may determine (e.g., ascertain, assess, decide, or a combination thereof, etc.) if an affirmative authentication procedure (e.g., entering a password, passcode, pattern, or a combination thereof, etc.; providing a biometric input such as a facial image, a fingerprint, an iris scan, or a combination thereof, etc.; answering one or more questions; some combination thereof; or so forth) is to be administered (e.g., offered, required, exposed, or a combination thereof, etc.) to a user 104 of a user device 102 based at least partly on at least one indicator of a proximity 706 of at least one corroborative user device 102c. By way of example but not limitation, a server may determine if an affirmative authentication procedure is to be administered to a user of a user device based at least partly on at least one indicator of a proximity of at least one corroborative user device (e.g., a Norton server that is providing security for an HTC Windows Phone 8 smartphone may determine whether or not a user will be asked or required to enter a password for the user to be authenticated). However, claimed subject matter is not limited to any particular described embodiments, implementations, examples, etc.

For certain example embodiments, an operation 910 may be directed at least partially to wherein the determining if an affirmative authentication procedure is to be administered to a user of the user device based at least partly on the at least one indicator of a proximity of the at least one corroborative user device (of operation 908) comprises signaling that the user of the user device is authenticated based at least partly on the at least one indicator of a proximity of the at least one corroborative user device. For certain example implementations, at least one device may signal (e.g., provide an indication, set a flag, send a transmission, transmit at least one packet, permit an authorization process to begin or continue, enable an authorization process to conclude, or a combination thereof, etc.) that a user 104 of a user device 102 is authenticated based at least partly on the at least one indicator 706 of a proximity of at least one corroborative user device 102c. By way of example but not limitation, a server may signal that a user of a user device is authenticated based at least partly on at least one indicator of a proximity of a at least one corroborative user device (e.g., a server providing Google Wallet services may send a transmission to a Samsung Galaxy Android phone that a current user thereof is considered an actual authorized user based at least partly on a friend's iPhone being in a same business facility). However, claimed subject matter is not limited to any particular described embodiments, implementations, examples, etc.

For certain example embodiments, an operation 912 may be directed at least partially to wherein the signaling that the user of the user device is authenticated based at least partly on the at least one indicator of a proximity of the at least one corroborative user device (of operation 910) comprises signaling that the user of the user device is authenticated based at least partly on the at least one indicator of a proximity of the at least one corroborative user device without requiring administration of the affirmative authentication procedure. For certain example implementations, at least one device may signal (e.g., provide an indication, set a flag, send a transmission, transmit at least one packet, permit an authorization process to begin or continue, enable an authorization process to conclude, or a combination thereof, etc.) that a user 104 of a user device 102 is authenticated based at least partly on at least one indicator of a proximity 706 of at least one corroborative user device 102c without requiring administration of an affirmative authentication procedure (e.g., entering a password, passcode, pattern, or a combination thereof, etc.; providing a biometric input such as a facial image, a fingerprint, an iris scan, or a combination thereof, etc.; answering one or more questions; some combination thereof; or so forth). By way of example but not limitation, a server may signal that a user of a user device is authenticated based at least partly on at least one indicator of a proximity of at least one corroborative user device without requiring administration of an affirmative authentication procedure (e.g., a PayPal server may transmit a positive authentication indication to an Apple iPhone for a current user thereof based at least partly on the user's child's iPad being located in a nearby parking lot without having the current user provide a fingerprint or other biological-based identification input to the iPhone). However, claimed subject matter is not limited to any particular described embodiments, implementations, examples, etc.

For certain example embodiments, an operation 914 may be directed at least partially to wherein the determining if an affirmative authentication procedure is to be administered to a user of the user device based at least partly on the at least one indicator of a proximity of the at least one corroborative user device (of operation 908) comprises initiating administration of the affirmative authentication procedure to the user of the user device based at least partly on the at least one indicator of a proximity of the at least one corroborative user device. For certain example implementations, at least one device may initiate (e.g., start, cause to begin, prompt to be performed, send a signal leading to, or a combination thereof, etc.) administration (e.g., offering, application, requirement, exposure, or a combination thereof, etc.) of an affirmative authentication procedure (e.g., entering a password, passcode, pattern, or a combination thereof, etc.; providing a biometric input such as a facial image, a fingerprint, an iris scan, or a combination thereof, etc.; answering one or more questions; some combination thereof; or so forth) to a user 104 of a user device 102 based at least partly on at least one indicator 706 of a proximity of at least one corroborative user device 102c. By way of example but not limitation, a server may initiate administration of an affirmative authentication procedure to a user of a user device based at least partly on at least one indicator of a proximity of at least one corroborative user device (e.g., a Microsoft server may send a signal to a Windows Phone instructing it to request that a current user thereof provide a pattern input over an image to authenticate the current user as an authorized user based at least partly on a determination that a nearest affiliated device is over two miles away or in a different city). However, claimed subject matter is not limited to any particular described embodiments, implementations, examples, etc.

FIG. 9B illustrates a flow diagram 900B having example operations 918, 920, 922, or 924. For certain example embodiments, an operation 918 may be directed at least partially to wherein the incorporating the at least one indicator of a proximity of the at least one corroborative user device into an authentication-related analysis for a user device that is associated with the behavioral fingerprint (of operation 804) comprises incorporating the at least one indicator of a proximity of the at least one corroborative user device and at least one indicator of a proximity of at least one other corroborative user device into the authentication-related analysis for the user device that is associated with the behavioral fingerprint. For certain example implementations, at least one device may incorporate 710 at least one indicator of a proximity 706-1 of at least one corroborative user device 102c-1 and at least one indicator of a proximity 706-2 of at least one other corroborative user device 102c-2 into an authentication-related analysis 708 for a user device 102 that is associated with a behavioral fingerprint 110. By way of example but not limitation, a server may incorporate at least one indicator of a proximity of at least one corroborative user device and at least one indicator of a proximity of at least one other corroborative user device into an authentication-related analysis for a user device that is associated with a behavioral fingerprint (e.g., a Walmart server may consider a proximity of a user's tablet and a proximity of a user's spouse's smartphone if the user is attempting to make a purchase at a Walmart checkout/payment area/zone with the user's smartphone). However, claimed subject matter is not limited to any particular described embodiments, implementations, examples, etc.

For certain example embodiments, an operation 920 may be directed at least partially to wherein the incorporating the at least one indicator of a proximity of the at least one corroborative user device and at least one indicator of a proximity of at least one other corroborative user device into the authentication-related analysis for the user device that is associated with the behavioral fingerprint (of operation 918) comprises determining if an affirmative authentication procedure is to be administered to the user of the user device based at least partly on the at least one indicator of a proximity of the at least one corroborative user device, which is associated with a first person, and based at least partly on the at least one indicator of a proximity of the at least one other corroborative user device, which is associated with a second person. For certain example implementations, at least one device may determine (e.g., ascertain, decide, conclude, or a combination thereof, etc.) if an affirmative authentication procedure (e.g., entering a password, passcode, pattern, or a combination thereof, etc.; providing a biometric input such as a facial image, a fingerprint, an iris scan, or a combination thereof, etc.; answering one or more questions; some combination thereof; or so forth) is to be administered to a user 104 of a user device 102 based at least partly on at least one indicator 706-1 of a proximity of at least one corroborative user device 102c-1, which is associated with a first person, and based at least partly on at least one indicator 706-2 of a proximity of at least one other corroborative user device 102c-2, which is associated with a second person. By way of example but not limitation, a server may determine if an affirmative authentication procedure is to be administered to a user of a user device based at least partly on at least one indicator of a proximity of at least one corroborative user device, which is associated with a first person, and based at least partly on at least one indicator of a proximity of at least one other corroborative user device, which is associated with a second person (e.g., an Apple server may determine if an Apple account holder is required to enter a PIN on an iPhone being used to make a purchase with Passbook based at least partly on whether a first friend's iPhone and a second friend's iPhone (e.g., at least two friends' iPhones) are both within 30 feet of the Apple account holder). However, claimed subject matter is not limited to any particular described embodiments, implementations, examples, etc.

For certain example embodiments, an operation 922 may be directed at least partially to wherein the incorporating the at least one indicator of a proximity of the at least one corroborative user device into an authentication-related analysis for a user device that is associated with the behavioral fingerprint (of operation 804) comprises incorporating the at least one indicator of a proximity of the at least one corroborative user device, which is associated with a parent, into the authentication-related analysis for the user device that is associated with the behavioral fingerprint, with the user device or the behavioral fingerprint being associated with a child of the parent. For certain example implementations, at least one device may incorporate 710 at least one indicator of a proximity 706 of at least one corroborative user device 102c, which is associated with a parent, into an authentication-related analysis 708 for a user device 102 that is associated with a behavioral fingerprint 110, with user device 102 or behavioral fingerprint 110 being associated with a child of the parent. By way of example but not limitation, a server may incorporate at least one indicator of a proximity of at least one corroborative user device, which is associated with a parent, into an authentication-related analysis for a user device that is associated with a behavioral fingerprint, with the user device or the behavioral fingerprint being associated with a child of the parent (e.g., a Visa server may consider a location of a parent's mobile phone if determining whether to require a child to supply a fingerprint scan if a mobile device of the child is attempting to order a movie). However, claimed subject matter is not limited to any particular described embodiments, implementations, examples, etc.

For certain example embodiments, an operation 924 may be directed at least partially to wherein the incorporating the at least one indicator of a proximity of the at least one corroborative user device into an authentication-related analysis for a user device that is associated with the behavioral fingerprint (of operation 804) comprises incorporating the at least one indicator of a proximity of the at least one corroborative user device into the authentication-related analysis for the user device that is associated with the behavioral fingerprint, the at least one corroborative user device at least one of (i) forming at least a part of or (ii) being coupled by wire to an internet-connected vehicle of a user of the user device. For certain example implementations, at least one device may incorporate 710 at least one indicator 706 of a proximity of at least one corroborative user device 102c into an authentication-related analysis 708 for a user device 102 that is associated with a behavioral fingerprint 110, with at least one corroborative user device 102c at least one of (i) forming at least a part of (e.g., being integrated with) or (ii) being coupled by wire to (e.g., being plugged into via a cable) an internet-connected vehicle (e.g., a motorcycle, a moped, a car, a truck, a van, or a combination thereof, etc.) of a user 104 of user device 102. By way of example but not limitation, a server may incorporate at least one indicator of a proximity of at least one corroborative user device into an authentication-related analysis for a user device that is associated with a behavioral fingerprint, with the at least one corroborative user device at least one of (i) forming at least a part of or (ii) being coupled by wire to an internet-connected vehicle of a user of the user device (e.g., a Starbuck's computer server may determine to omit requiring a customer, who is using a mobile phone to make a purchase, to provide an additional indicia of identity if the customer's vehicle is in a parking lot of a Starbuck's store). However, claimed subject matter is not limited to any particular described embodiments, implementations, examples, etc.

FIG. 9C illustrates a flow diagram 900C having example operations 928, 930, or 932. For certain example embodiments, an operation 928 may be directed at least partially to wherein the incorporating the at least one indicator of a proximity of the at least one corroborative user device into an authentication-related analysis for a user device that is associated with the behavioral fingerprint (of operation 804) comprises incorporating at least one degree of the proximity of the at least one corroborative user device into the authentication-related analysis for the user device that is associated with the behavioral fingerprint. For certain example implementations, at least one device may incorporate 710 at least one degree (e.g., a length of distance, a level of positioning certainty, an error range, a size of an area, an amount of precision, or a combination thereof, etc.) of a proximity of at least one corroborative user device 102c into an authentication-related analysis 708 for a user device 102 that is associated with a behavioral fingerprint 110. By way of example but not limitation, a server may incorporate at least one degree of proximity of at least one corroborative user device into an authentication-related analysis for a user device that is associated with a behavioral fingerprint (e.g., a Norton server may adjust an authentication analysis to increase a probability that an affirmative authentication procedure may be omitted as a distance to a girlfriend's phone decreases). However, claimed subject matter is not limited to any particular described embodiments, implementations, examples, etc.

For certain example embodiments, an operation 930 may be directed at least partially to wherein the incorporating the at least one indicator of a proximity of the at least one corroborative user device into an authentication-related analysis for a user device that is associated with the behavioral fingerprint (of operation 804) comprises ascertaining at least one likelihood that a user of the user device is authentic based at least partly on the at least one indicator of a proximity of the at least one corroborative user device. For certain example implementations, at least one device may ascertain (e.g., determine, calculate, acquire, or a combination thereof, etc.) at least one likelihood (e.g., a probability, a numerical range, a percentage, a stochastic value, a confidence level, a result of a Bayesian analysis, or a combination thereof, etc.) that a user 104 of a user device 102 is authentic (e.g., is who he or she purports to be, is an authorized user, or a combination thereof, etc.) based at least partly on at least one indicator of a proximity 706 of at least one corroborative user device 102c. By way of example but not limitation, a server may ascertain at least one likelihood that a user of a user device is authentic based at least partly on at least one indicator of a proximity of at least one corroborative user device (e.g., a Google server may employ a stochastic mechanism to determine a probabilistic range that a current user of a Motorola Droid smartphone is an authorized user of the Motorola Droid smartphone based on data indicative of a friend's Apple iPhone being within 30 meters of the Motorola Droid smartphone). However, claimed subject matter is not limited to any particular described embodiments, implementations, examples, etc.

For certain example embodiments, an operation 932 may be directed at least partially to wherein the incorporating the at least one indicator of a proximity of the at least one corroborative user device into an authentication-related analysis for a user device that is associated with the behavioral fingerprint (of operation 804) comprises incorporating into the authentication-related analysis for the user device that is associated with the behavioral fingerprint a time indicative of a recency of a previous affirmative authentication by an authorized user of the at least one corroborative user device. For certain example implementations, at least one device may incorporate (e.g., include, factor, consider, add as in input or variable, or a combination thereof, etc.) into an authentication-related analysis 708 for a user device 102 that is associated with a behavioral fingerprint 110 a time (e.g., an absolute time such as a date or time of day, a relative time such as a number of hours since, a label such as “yesterday”, or a combination thereof, etc.) indicative of a recency of a (e.g., a most recent) previous affirmative authentication (e.g., entering a password, passcode, pattern, or a combination thereof, etc.; providing a biometric input such as a facial image, a fingerprint, an iris scan, or a combination thereof, etc.; answering one or more questions; some combination thereof; or so forth) by an authorized user of at least one corroborative user device 102c. By way of example but not limitation, a server may incorporate into an authentication-related analysis for a user device that is associated with a behavioral fingerprint a time indicative of a recency of a previous affirmative authentication by an authorized user of at least one corroborative user device (e.g., an Apple server may factor into an analysis, which is to determine whether a current user of an iPhone 5 is to be considered an authorized user thereof, a time duration that has elapsed since a brother of an authorized user of the iPhone 5 performed an affirmative authentication on the brother's iPhone 4s, which iPhone 4S is in the same building as the iPhone 5). However, claimed subject matter is not limited to any particular described embodiments, implementations, examples, etc.

FIG. 9D illustrates a flow diagram 900D having example operations 936, 938, or 940. For certain example embodiments, an operation 936 may be directed at least partially to wherein the incorporating the at least one indicator of a proximity of the at least one corroborative user device into an authentication-related analysis for a user device that is associated with the behavioral fingerprint (of operation 804) comprises incorporating the at least one indicator of a proximity of the at least one corroborative user device and one or more indicators of one or more behavior-related acts with regard to the at least one corroborative user device into the authentication-related analysis for the user device that is associated with the behavioral fingerprint. For certain example implementations, at least one device may incorporate 710 at least one indicator 706 of a proximity of at least one corroborative user device 102c and one or more indicators 302-324 (e.g., for user interface actions, user movements, apps employed, social network interactions, or a combination thereof, etc.) of one or more behavior-related acts (e.g., which indicators or acts may be reflected or included in a behavioral fingerprint 110c associated with a corroborative user device 102c) with regard to at least one corroborative user device 102c into an authentication-related analysis 708 for a user device 102 that is associated with a behavioral fingerprint 110. By way of example but not limitation, a server may incorporate at least one indicator of a proximity of at least one corroborative user device and one or more indicators of one or more behavior-related acts with regard to the at least one corroborative user device into an authentication-related analysis for a user device that is associated with a behavioral fingerprint (e.g., a Google server may consider (i) a distance between a Google account holder's Samsung Galaxy Tab tablet computer and a Google account holder's Samsung Galaxy smartphone and (ii) how a most-recent user of the Galaxy Tab tablet computer interacted with the Galaxy Tab tablet computer, e.g.—in relation to predict acts of a behavioral fingerprint that is associated with the Galaxy Tab tablet computer, when determining if a current user of the Galaxy smartphone is to be considered authenticated without a contemporaneous affirmative authentication at the Galaxy smartphone). However, claimed subject matter is not limited to any particular described embodiments, implementations, examples, etc.

For certain example embodiments, an operation 938 may be directed at least partially to wherein the incorporating the at least one indicator of a proximity of the at least one corroborative user device and one or more indicators of one or more behavior-related acts with regard to the at least one corroborative user device into the authentication-related analysis for the user device that is associated with the behavioral fingerprint (of operation 936) comprises incorporating one or more indicators of one or more transactions conducted at least partially by the at least one corroborative user device at a current location into the authentication-related analysis for the user device that is associated with the behavioral fingerprint. For certain example implementations, at least one device may incorporate one or more indicators 316, 320, or 322 of one or more transactions conducted (e.g., purchases made, orders placed, services paid for, or a combination thereof, etc.) at least partially by at least one corroborative user device 102c at a current location (e.g., a location, such as a store or restaurant, that a corroborative user device 102c or a user device 102 is positioned at a time of analysis) into an authentication-related analysis 708 for a user device 102 that is associated with a behavioral fingerprint 110. By way of example but not limitation, a server may incorporate one or more indicators of one or more transactions conducted at least partially by at least one corroborative user device at a current location into an authentication-related analysis for a user device that is associated with a behavioral fingerprint (e.g., a Google Wallet server may consider what electronic or financial transactions were previously conducted using a spouse's HTC Windows Phone 8 smartphone at a particular mall if the HTC Windows Phone 8 smartphone and a Samsung Galaxy smartphone are both at the particular mall when deciding whether to require a current user of the Samsung Galaxy smartphone to authenticate with the Samsung Galaxy smartphone before considering whether an action that is requested with the Samsung Galaxy smartphone is to be authorized). However, claimed subject matter is not limited to any particular described embodiments, implementations, examples, etc.

For certain example embodiments, an operation 940 may be directed at least partially to wherein the incorporating the at least one indicator of a proximity of the at least one corroborative user device and one or more indicators of one or more behavior-related acts with regard to the at least one corroborative user device into the authentication-related analysis for the user device that is associated with the behavioral fingerprint (of operation 936) comprises incorporating one or more indicators of one or more physical interactions with the at least one corroborative user device into the authentication-related analysis for the user device that is associated with the behavioral fingerprint. For certain example implementations, at least one device may incorporate one or more indicators 302, 304, 306, 310, 320, or 322 of one or more physical interactions (e.g., user interface actions, user movements, locations visited, communication modes employed, or a combination thereof, etc.) with at least one corroborative user device 102c into an authentication-related analysis 708 for a user device 102 that is associated with a behavioral fingerprint 110. By way of example but not limitation, a server may incorporate one or more indicators of one or more physical interactions with at least one corroborative user device into an authentication-related analysis for a user device that is associated with a behavioral fingerprint (e.g., a Google server may account for what user interactions have recently occurred with respect to a Samsung Galaxy Tab tablet computer if the Samsung Galaxy Tab tablet computer is in proximity with a Samsung Galaxy smartphone when deciding whether to require a current user of the Samsung Galaxy smartphone to perform an affirmative authentication with the Samsung Galaxy smartphone). However, claimed subject matter is not limited to any particular described embodiments, implementations, examples, etc.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

This application may make reference to one or more trademarks, e.g., a word, letter, symbol, or device adopted by one manufacturer or merchant and used to identify and distinguish his or her product from those of others. Trademark names used herein are set forth in such language that makes clear their identity, that distinguishes them from common descriptive nouns, that have fixed and definite meanings, and, in many if not all cases, are accompanied by other specific identification using terms not covered by trademark. In addition, trademark names used herein have meanings that are well-known and defined in the literature, and do not refer to products or compounds protected by trade secrets in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or [trade], even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for behavioral fingerprinting via corroborative user device, the method being at least partially implemented by a device, the method comprising:
ascertaining at least one indicator of a proximity of at least one corroborative user device that is affiliated with a behavioral fingerprint; and
incorporating the at least one indicator of a proximity of the at least one corroborative user device into an authentication-related analysis for a user device that is associated with the behavioral fingerprint.

2. The method of claim 1, wherein the ascertaining at least one indicator of a proximity of at least one corroborative user device that is affiliated with a behavioral fingerprint comprises:
ascertaining at least one indicator of a location of the at least one corroborative user device that is affiliated with the behavioral fingerprint.

3. The method of claim 2, wherein the ascertaining at least one indicator of a location of the at least one corroborative user device that is affiliated with the behavioral fingerprint comprises:
receiving one or more geographical coordinates representing the location of the at least one corroborative user device that is affiliated with the behavioral fingerprint.

4. The method of claim 2, wherein the ascertaining at least one indicator of a location of the at least one corroborative user device that is affiliated with the behavioral fingerprint comprises:
receiving one or more positional ranges representing the location of the at least one corroborative user device that is affiliated with the behavioral fingerprint.

5. The method of claim 2, wherein the ascertaining at least one indicator of a location of the at least one corroborative user device that is affiliated with the behavioral fingerprint comprises:
determining a distance between the at least one corroborative user device that is affiliated with the behavioral fingerprint and the user device that is associated with the behavioral fingerprint based at least partially on the at least one indicator of a location of the at least one corroborative user device that is affiliated with the behavioral fingerprint.

6. The method of claim 1, wherein the ascertaining at least one indicator of a proximity of at least one corroborative user device that is affiliated with a behavioral fingerprint comprises:
ascertaining at least one indicator of a distance between the at least one corroborative user device that is affiliated with the behavioral fingerprint and the user device that is associated with the behavioral fingerprint.

7. The method of claim 6, wherein the ascertaining at least one indicator of a distance between the at least one corroborative user device that is affiliated with the behavioral fingerprint and the user device that is associated with the behavioral fingerprint comprises:
receiving the at least one indicator of a distance between the at least one corroborative user device that is affiliated with the behavioral fingerprint and the user device that is associated with the behavioral fingerprint.

8. The method of claim 6, wherein the ascertaining at least one indicator of a distance between the at least one corroborative user device that is affiliated with the behavioral fingerprint and the user device that is associated with the behavioral fingerprint comprises:
determining the at least one indicator of a distance between the at least one corroborative user device that is affiliated with the behavioral fingerprint and the user device that is associated with the behavioral fingerprint based at least partly on a location of the at least one corroborative user device and a location of the user device.

9. The method of claim 6, wherein the ascertaining at least one indicator of a distance between the at least one corroborative user device that is affiliated with the behavioral fingerprint and the user device that is associated with the behavioral fingerprint comprises:
determining the at least one indicator of a distance between the at least one corroborative user device that is affiliated with the behavioral fingerprint and the user device that is associated with the behavioral fingerprint based at least partly on at least one Wi-Fi network detectable by the at least one corroborative user device and at least one Wi-Fi network detectable by the user device.

10. The method of claim 1, wherein the ascertaining at least one indicator of a proximity of at least one corroborative user device that is affiliated with a behavioral fingerprint comprises:
ascertaining at least one indicator that the at least one corroborative user device that is affiliated with the behavioral fingerprint is out of range of the user device that is associated with the behavioral fingerprint.

11. The method of claim 1, wherein the ascertaining at least one indicator of a proximity of at least one corroborative user device that is affiliated with a behavioral fingerprint comprises:
ascertaining at least one indicator that the at least one corroborative user device that is affiliated with the behavioral fingerprint is in range of the user device that is associated with the behavioral fingerprint.

12. The method of claim 1, wherein the ascertaining at least one indicator of a proximity of at least one corroborative user device that is affiliated with a behavioral fingerprint comprises:
ascertaining at least one indicator of a proximity of at least one first corroborative user device that is affiliated with the behavioral fingerprint and at least one indicator of a proximity of at least one second corroborative user device.

13. The method of claim 1, wherein the ascertaining at least one indicator of a proximity of at least one corroborative user device that is affiliated with a behavioral fingerprint comprises:
ascertaining the at least one indicator of a proximity of the at least one corroborative user device that is affiliated with the behavioral fingerprint and that is associated with the behavioral fingerprint.

14. The method of claim 1, wherein the ascertaining at least one indicator of a proximity of at least one corroborative user device that is affiliated with a behavioral fingerprint comprises:
ascertaining the at least one indicator of a proximity of the at least one corroborative user device (i) that is affiliated with the behavioral fingerprint and (ii) that is associated with another behavioral fingerprint, the other behavioral fingerprint associated with a spouse of a user of the user device.

15. The method of claim 1, wherein the ascertaining at least one indicator of a proximity of at least one corroborative user device that is affiliated with a behavioral fingerprint comprises:
ascertaining, during a time of a scheduled event, the at least one indicator of a proximity of the at least one corroborative user device that is affiliated with the behavioral fingerprint and that is associated with a particular person, the scheduled event relating to at least the particular person and a user of the user device.

16. The method of claim 15, wherein the ascertaining, during a time of a scheduled event, the at least one indicator of a proximity of the at least one corroborative user device that is affiliated with the behavioral fingerprint and that is associated with a particular person, the scheduled event relating to at least the particular person and a user of the user device comprises:
accessing calendar data corresponding to the scheduled event to obtain at least one identifier of the particular person.

17. The method of claim 1, wherein the ascertaining at least one indicator of a proximity of at least one corroborative user device that is affiliated with a behavioral fingerprint comprises:
identifying the at least one corroborative user device based at least partially on one or more social network connections of a user that is associated with the behavioral fingerprint.

18. The method of claim 1, wherein the ascertaining at least one indicator of a proximity of at least one corroborative user device that is affiliated with a behavioral fingerprint comprises:
obtaining at least one designation that the at least one corroborative user device is affiliated with the behavioral fingerprint.

19. The method of claim 18, wherein the obtaining at least one designation that the at least one corroborative user device is affiliated with the behavioral fingerprint comprises:
detecting that the at least one corroborative user device is linked to a same account as the user device.

20. The method of claim 18, wherein the obtaining at least one designation that the at least one corroborative user device is affiliated with the behavioral fingerprint comprises:
detecting at least one implicit temporary designation for the at least one corroborative user device based at least partially on at least one scheduled event of a calendar that is associated with the user device.

21. (canceled)

22. The method of claim 18, wherein the obtaining at least one designation that the at least one corroborative user device is affiliated with the behavioral fingerprint comprises:
detecting an affiliation designation based at least partially on a short-range communication between the user device and the at least one corroborative user device.

23. The method of claim 1, wherein the incorporating the at least one indicator of a proximity of the at least one corroborative user device into an authentication-related analysis for a user device that is associated with the behavioral fingerprint comprises:
determining if an affirmative authentication procedure is to be administered to a user of the user device based at least partly on the at least one indicator of a proximity of the at least one corroborative user device.

24. The method of claim 23, wherein the determining if an affirmative authentication procedure is to be administered to a user of the user device based at least partly on the at least one indicator of a proximity of the at least one corroborative user device comprises:
signaling that the user of the user device is authenticated based at least partly on the at least one indicator of a proximity of the at least one corroborative user device.

25. (canceled)

26. The method of claim 23, wherein the determining if an affirmative authentication procedure is to be administered to a user of the user device based at least partly on the at least one indicator of a proximity of the at least one corroborative user device comprises:
initiating administration of the affirmative authentication procedure to the user of the user device based at least partly on the at least one indicator of a proximity of the at least one corroborative user device.

27. The method of claim 1, wherein the incorporating the at least one indicator of a proximity of the at least one corroborative user device into an authentication-related analysis for a user device that is associated with the behavioral fingerprint comprises:
incorporating the at least one indicator of a proximity of the at least one corroborative user device and at least one indicator of a proximity of at least one other corroborative user device into the authentication-related analysis for the user device that is associated with the behavioral fingerprint.

28. The method of claim 27, wherein the incorporating the at least one indicator of a proximity of the at least one corroborative user device and at least one indicator of a proximity of at least one other corroborative user device into the authentication-related analysis for the user device that is associated with the behavioral fingerprint comprises:
determining if an affirmative authentication procedure is to be administered to the user of the user device based at least partly on the at least one indicator of a proximity of the at least one corroborative user device, which is associated with a first person, and based at least partly on the at least one indicator of a proximity of the at least one other corroborative user device, which is associated with a second person.

29. The method of claim 1, wherein the incorporating the at least one indicator of a proximity of the at least one corroborative user device into an authentication-related analysis for a user device that is associated with the behavioral fingerprint comprises:
incorporating the at least one indicator of a proximity of the at least one corroborative user device, which is associated with a parent, into the authentication-related analysis for the user device that is associated with the behavioral fingerprint, with the user device or the behavioral fingerprint being associated with a child of the parent.

30. The method of claim 1, wherein the incorporating the at least one indicator of a proximity of the at least one corroborative user device into an authentication-related analysis for a user device that is associated with the behavioral fingerprint comprises:
incorporating the at least one indicator of a proximity of the at least one corroborative user device into the authentication-related analysis for the user device that is associated with the behavioral fingerprint, the at least one corroborative user device at least one of (i) forming at least a part of or (ii) being coupled by wire to an internet-connected vehicle of a user of the user device.

31. The method of claim 1, wherein the incorporating the at least one indicator of a proximity of the at least one corroborative user device into an authentication-related analysis for a user device that is associated with the behavioral fingerprint comprises:
incorporating at least one degree of the proximity of the at least one corroborative user device into the authentication-related analysis for the user device that is associated with the behavioral fingerprint.

32. The method of claim 1, wherein the incorporating the at least one indicator of a proximity of the at least one corroborative user device into an authentication-related analysis for a user device that is associated with the behavioral fingerprint comprises:
ascertaining at least one likelihood that a user of the user device is authentic based at least partly on the at least one indicator of a proximity of the at least one corroborative user device.

33. The method of claim 1, wherein the incorporating the at least one indicator of a proximity of the at least one corroborative user device into an authentication-related analysis for a user device that is associated with the behavioral fingerprint comprises:
incorporating into the authentication-related analysis for the user device that is associated with the behavioral fingerprint a time indicative of a recency of a previous affirmative authentication by an authorized user of the at least one corroborative user device.

34. The method of claim 1, wherein the incorporating the at least one indicator of a proximity of the at least one corroborative user device into an authentication-related analysis for a user device that is associated with the behavioral fingerprint comprises:
incorporating the at least one indicator of a proximity of the at least one corroborative user device and one or more indicators of one or more behavior-related acts with regard to the at least one corroborative user device into the authentication-related analysis for the user device that is associated with the behavioral fingerprint.

35. The method of claim 34, wherein the incorporating the at least one indicator of a proximity of the at least one corroborative user device and one or more indicators of one or more behavior-related acts with regard to the at least one corroborative user device into the authentication-related analysis for the user device that is associated with the behavioral fingerprint comprises:
incorporating one or more indicators of one or more transactions conducted at least partially by the at least one corroborative user device at a current location into the authentication-related analysis for the user device that is associated with the behavioral fingerprint.

36. (canceled)

37. A system for behavioral fingerprinting via corroborative user device, the system comprising:
circuitry for ascertaining at least one indicator of a proximity of at least one corroborative user device that is affiliated with a behavioral fingerprint; and
circuitry for incorporating the at least one indicator of a proximity of the at least one corroborative user device into an authentication-related analysis for a user device that is associated with the behavioral fingerprint.

38.-72. (canceled)

73. A system for behavioral fingerprinting via corroborative user device, the system comprising:
means for ascertaining at least one indicator of a proximity of at least one corroborative user device that is affiliated with a behavioral fingerprint; and
means for incorporating the at least one indicator of a proximity of the at least one corroborative user device into an authentication-related analysis for a user device that is associated with the behavioral fingerprint.

74.-108. (canceled)

109. The method of claim 24, wherein the signaling that the user of the user device is authenticated based at least partly on the at least one indicator of a proximity of the at least one corroborative user device comprises:
signaling that the user of the user device is authenticated based at least partly on the at least one indicator of a proximity of the at least one corroborative user device without requiring administration of the affirmative authentication procedure.

110. The method of claim 1, wherein the incorporating the at least one indicator of a proximity of the at least one corroborative user device into an authentication-related analysis for a user device that is associated with the behavioral fingerprint comprises:
incorporating one or more indicators of one or more physical interactions with the user device into the behavioral fingerprint that is associated with the user device.
